(19) United States
(12) Patent Application Publication
(10) Pub. No.: US 2024/0110009 A1
(43) Pub. Date: Apr. 4, 2024

(54) NEW ALKOXYLATED POLYALKYLENE IMINES OR ALKOXYLATED POLYAMINES

(71) Applicant: BASF SE, Ludwigshafen (DE)

(72) Inventors: Sophia EBERT, Ludwigshafen (DE); Susanne Carina ENGERT, Ludwigshafen (DE); Guido VANDERMEULEN, Ludwigshafen (DE); Catharina WOHLMUTH, Ludwigshafen (DE)

(21) Appl. No.: 18/257,173

(22) PCT Filed: Dec. 21, 2021
(86) PCT No.: PCT/EP2021/087053

§ 371 Date: Jun. 13, 2023

(30) Foreign Application Priority Data
Dec. 23, 2020 (EP) 20216952.0
May 31, 2021 (EP) 21176904.7

(51) Int. Cl. C08G 73/02; C11D 3/37; C11D 11/00

(52) U.S. Cl. CPC C08G 73/0206; C11D 3/3723; C11D 11/0017

(57) ABSTRACT

Disclosed herein is a method for preparing a multilayer coating system on a substrate including at least the steps of applying a first coating material composition to a substrate (step (1)), applying a second coating material composition to the first coating film formed in step (1) prior to curing the first coating film and forming a second coating film (step (2)) and jointly curing the first and second coating films (step (3)). Also disclosed herein are a multilayer coating system on a substrate, which is obtainable by the method and a method of using an amino resin (AR) as a migrating crosslinking agent.

The present invention relates to novel alkoxylated polyalkylene imines or alkoxylated polyamines obtainable by a process comprising the steps a) to c). According to step a), a polyalkylene imine or a polyamine as such is reacted with a first alkylene oxide (AO1) in order to obtain a first intermediate (I1). Said first intermediate (I1) is reacted with a lactone and/or a hydroxy carbon acid in step b) in order to obtain a second intermediate (I2). Afterwards, said second intermediate (I2) is reacted with a second alkylene oxide (AO2) in order to obtain the novel alkoxylated polyalkylene imines or alkoxylated polyamines according to the present invention. The present invention further relates to a process as such for preparing such alkoxylated polyalkylene imines or alkoxylated polyamines as well as to the use of such compounds within, for example, cleaning compositions and/or in fabric and home care products. Furthermore, the present invention also relates to those compositions or products as such.

Detergent formulators are continuously faced with the task of developing improved products to remove a broad spectrum of soils and stains from fabrics and hard surfaces. Chemically and physico-chemically, the varieties of soils and stains range the spectrum from polar soils, such as proteinaceous, clay, and inorganic soils, to non-polar soils, such as soot, carbon-black, by-products of incomplete hydrocarbon combustion, and organic soils like sebum. The removal of particulate stains has been a particularly challenging problem. This challenge has been accentuated by the recent high interest and motivation to employ sustainable and biobased and/or biodegradable components for laundry detergents and manual dish wash. This leads to a high market demand for new raw materials that have a satisfying performance profile combined with significantly improved biodegradability.

As a result of these trends, there is a strong need for new cleaning polymers that provide both excellent primary (i.e. soil removal) and secondary (i.e. whiteness maintenance) cleaning benefits for both hydrophobic and hydrophilic stains. The materials should exhibit good soil removal for particulate and oily/fatty stains and should also lead to improved whiteness maintenance, minimizing the amount of suspended and emulsified oily/fatty and particulate soil from redepositing on the surfaces of the textiles or hard surfaces. Preferably, the new ingredients would also display a synergy with other cleaning polymers known for improving solely the oily/fatty or particulate stain removal and/or whiteness of fabrics and hard surfaces, leading to further improved detergent compositions.

Generally spoken, the currently known alkoxylated polyethylene imines are not biodegradable to any significant extent, certainly not under defined conditions within 28 days as to be required by many users especially the filed of detergents, and as being a future requirement by applicable legislation in several countries and regions of the world.

WO 2015/028191 relates to water-soluble alkoxylated polyalkylene imines having an inner block of polyethylene oxide comprising 5 to 18 polyethylene oxide units, a middle block of polyalkylene oxide comprising 1 to 5 polyalkylene oxide units and an outer block of polyethylene oxide comprising 2 to 14 polyethylene oxide units. The middle block is formed from polypropylene oxide units, polybutylene oxide units and/or polypentene oxide units. In addition, WO 2015/028191 relates to water-soluble alkoxylated polyamines.

WO 2020/187648 also relates to polyalkoxylated polyalkylene imines or alkoxylated polyamines according to a general formula (I). The compounds described therein may be employed within, for example, cosmetic formulations. However, the specific compounds disclosed within WO 2020/187648 differ from the respective compounds of the present invention. Since the substituents of WO 2020/187648 do not comprise any fragments based on lactones and/or hydroxy carbon acids.

GB-A 2 562 172 relates to specific functionalized polyalkylene imine polymers according to general formula (I), which compositions are employed as pigment dispersions. GB-A 2 562 172 does not disclose any alkoxylated polyalkylene imine or alkoxylated polyamines containing any substituents having fragments based on alkylene oxide, followed by a lactone and/or hydroxy carbon acid based fragment and followed again by another alkylene oxide based fragment.

WO 95/32272 describes ethoxylated and/or propoxylated polyalkylene amine polymers to boost soil dispersing performance, wherein said polymers have an average ethoxylation/propoxylation of from 0.5 to 10 per nitrogen.

EP-A 0 759 440 discloses a dispersing agent for solids based on the phosphonation at the end groups of compounds such as a polyurethane. A polyurethane as such is obtained by the reaction of an amine with an alkylene oxide or an alkylene carbonate, wherein 50 to 100% of the NH-functionalities of the respective amine are oxylated. Afterwards, the respective intermediate (aminoalcohol) is again reacted with a hydroxy carboxylic acid or a diacid and a diol in order to obtain a polyester, or a respective reaction with a diisocyanate is carried out in order to obtain such a polyurethane. The various individual intermediates of the second reaction step are phosphonated within a last reaction step afterwards. By consequence, EP-A 0 759 440 does not disclose any alkoxylated polyalkylated imines or alkoxylated polyamines according to the present invention obtainable by a process comprising the steps a) to c) as defined below.

US-A 2020/392286 relates to an acid functional compound comprising at least one segment consisting of at least one ether unit E and at least one ester unit, wherein the ether units and ester units are connected by an ether link or by an ester link, and wherein the ether units and ester units are arranged in a random order, and at least one acidic group, wherein the at least one acidic group is covalently linked to the at least one segment. US-A 2020/392286 does not disclose any alkoxylated polyalkylated imines or alkoxylated polyamines according to the present invention, obtainable by a process comprising the steps a) to c) as defined below.

US-A 2015/122742 is related to demulsifiers to break emulsions, particularly oilfield emulsions, based on lactone/alkylene oxide polymers. These polymers are made from addition reactions of a hydroxyl- and/or amine-containing base compound with at least one lactone monomer and at least one alkylene oxide monomer. US-A 2015/122742 does not disclose any alkoxylated polyalkylated imines or alkoxylated polyamines according to the present invention, obtainable by a process comprising the steps a) to c) as defined below.

The object of the present invention is to provide novel compounds based on a polyalkylene imine backbone or a polyamine backbone. Furthermore, those novel compounds should have beneficial properties when being employed within compositions in respect of their biodegradability.

The object is achieved by an alkoxylated polyalkylene imine or alkoxylated polyamine obtainable by a process comprising the steps a) to c) as follows:
a) reaction of i) at least one polyalkylene imine or at least one polyamine with ii) at least one first alkylene oxide (AO1), wherein 0.25 to 7.0 mol of alkylene oxide (AO1) is employed per mol of NH-functionality of polyalkylene imine or of polyamine, in order to obtain a first intermediate (I1),
b) reaction of the first intermediate (I1) with at least one lactone and/or at least one hydroxy carbon acid, wherein 0.25 to 10 mol of lactone and/or of hydroxy carbon acid is employed per mol of NH-functionality of polyalkylene imine or of polyamine (as employed in step a)), in order to obtain a second intermediate (I2),
c) reaction of the second intermediate (I2) with at least one second alkylene oxide (AO2), wherein at least 1 mol of alkylene oxide (AO2) is employed per mol of NH-functionality of polyalkylene imine or of polyamine (as employed in step a)), in order to obtain the alkoxylated polyalkylene imine or the alkoxylated polyamine.

The alkoxylated compounds according to the present invention may be used in cleaning compositions, particularly a laundry detergent composition or a manual dish wash detergent composition, comprising (i) at least one alkoxylated compound as defined above, and (ii) at least one surfactant.

Furthermore, the alkoxylated compounds as defined above can be used for laundry care or manual dishwashing.

Furthermore, the alkoxylated compounds as defined above can be used as additive for detergent formulations, in particular for liquid detergent formulations, or concentrated liquid detergent formulations, or single mono doses for laundry.

The alkoxylated compounds according to the present invention lead to at least comparable and preferably even improved cleaning performance of said composition, for example in respect of removing particulate stains, such as clay, compared to corresponding alkoxylated compounds according to the prior art. Beyond that, the alkoxylated compounds according to the present invention lead to an improved biodegradability when being employed within compositions, for example, within cleaning compositions.

For the purposes of the present invention, definitions such as C₁-C₂₂-alkyl, as defined below for, for example, the radical R² in formula (IIa), mean that this substituent (radical) is an alkyl radical having from 1 to 22 carbon atoms. The alkyl radical can be either linear or branched or optionally cyclic. Alkyl radicals which have both a cyclic component and a linear component likewise come within this definition. The same applies to other alkyl radicals such as a C₁-C₄-alkyl radical. Examples of alkyl radicals are methyl, ethyl, n-propyl, sec-propyl, n-butyl, sec-butyl, isobutyl, 2-ethylhexyl, tert-butyl (tert-Bu/t-Bu), pentyl, hexyl, heptyl, cyclohexyl, octyl, nonyl, decyl or dodecyl.

The term “C₂-C₂₂-alkylene” as used herein refers to a saturated, divalent straight chain or branched hydrocarbon chains of 2, 3, 4, 5, 6, 10, 12 or up to 22 carbon atoms, examples including ethane-1,2-diyl (“ethylene”), propane-1,3-diyl, propane-1,2-diyl, 2-methylpropane-1,2-diyl, 2,2-dimethylpropane-1,3-diyl, butane-1,4-diyl, butane-1,3-diyl (=1-methylpropane-1,3-diyl), butane-1,2-diyl (“1,2-butylene”), butane-2,3-diyl, 2-methyl-butan-1,3-diyl, 3-methyl-butan-1,3-diyl (=1,1-dimethylpropane-1,3-diyl), pentane-1,4-diyl, pentane-1,5-diyl, pentane-2,5-diyl, 2-methylpentane-2,5-diyl (=1,1-dimethylbutane-1,3-diyl) and hexane-1,6-diyl.

The term “C₅-C₁₀-cycloalkylene” as used herein refers to saturated, divalent hydrocarbons of 5, 6, 7, 8, 9 or 10 carbon atoms wherein all or at least a part of the respective number of carbon atoms form a cycle (ring). In case not all of the respective number of carbon atoms form a cycle, such remaining carbon atoms (i.e. those carbon atoms not forming a cycle) form a methane-1,1-diyl (“methylene”) fragment or an ethane-1,2-diyl (“ethylene”) fragment of the respective C₅-C₁₀-cycloalkylene radicals. One of the two valencies of said respective methylene or ethylene fragments is bound to a neighbouring nitrogen atom within general formula (I), whereas the second valency of said fragments is bound to the cyclic fragment of said C₅-C₁₀-cycloalkylene radical.

Expressed in other words, a C₅-C₁₀-cycloalkylene radical may comprise, in addition to its cyclic fragment, also some non-cyclic fragments building a bridge or a linker of the cyclic fragment of the C₅-C₁₀-cycloalkylene radical to the neighbouring nitrogen atom within general formula (I). The number of such carbon linker atoms is usually not more than 3, preferably 1 or 2. For example, a C₇-cycloalkylene radical may contain one C₆-cycle and one C₁-linker.

The respective hydrocarbon cycle itself may be unsubstituted or at least monosubstituted by C₁-C₃-alkyl. It has to be noted that the carbon atoms of the respective C₁-C₃-alkyl substituents are not considered for determination of the number of carbon atoms of the C₅-C₁₀-cycloalkylene radical. In contrast to that, the number of carbon atoms of such a C₅-C₁₀-cycloalkylene radical is solely determined without any substituents, but only by the number of carbon atoms of the cyclic fragment and optionally present carbon linker atoms (methylene or ethylene fragments).

Examples for C₅-C₁₀-cycloalkylene include cyclopentane-1,2-diyl, cyclohexane-1,2-diyl, cyclohexane-1,3-diyl, cyclohexane-1,4-diyl, 3-(methane-1,1-diyl)-cyclohexane-1,3-diyl, cycloheptane-1,3-diyl or cyclooctane-1,4-diyl, each of the aforementioned radicals may be at least monosubstituted with C₁-C₃-alkyl.

It is preferred that the respective C₅-C₁₀-cycloalkylene radical is employed as a mixture of two or more individual cycloalkylene radicals having the same ring size. It is particularly preferred to employ a mixture of cyclohexane-1,3-diyl monosubstituted with methyl in position 2 or 4, respectively, of the cycle. The ratio of the two compounds is preferably in a range of 95:5 to 75:25, most preferably about 85:15 (4-methyl versus 2-methyl).

3-(methane-1,1-diyl)-cyclohexane-1,3-diyl is a preferred example for a C₅-C₁₀-cyclo-alkylene radical having a non-cyclic fragment in addition to its cyclic fragment. For this specific case, the non-cyclic fragment is a C₁-linker and the cyclic fragment is a C₆-cycle resulting in a C₇-cycloalkylene radical. 3-(methane-1,1-diyl)-cyclohexane-1,3-diyl may also be substituted with at least one C₁-C₃-alkyl, preferably with three methyl groups, in particular 3,5,5-trimethyl. The latter one is a fragment of isophorone diamine, which may be emcycployed as backbone with general formula (I).

For the purposes of the present invention, the term “aralkyl”, as defined below for, for example, the radical R² in formula (IIa), means that the substituent (radical) is an aromatic (“ar”) combined with an alkyl substituent (“alkyl”). The aromatic “ar” part can be a monocyclic, bicyclic or optionally polycyclic aromatic. In the case of polycyclic aromatics, individual rings can optionally be fully or partially saturated. Preferred examples of aryl are phenyl, naphthyl or anthracyl, in particular phenyl.

Within the context of the present invention, the term “polyalkylene imine” differs from the corresponding term “polyamine” especially in respect of the branching of the compounds as such as employed within step a) as educt or within the backbone of the corresponding alkoxylated compounds as such as obtained within step c) of the inventive process. Whereas polyamines in the context of the present invention are (predominantly) linear compounds (in respect of its backbone without consideration of any alkoxylation), containing primary and/or secondary amino moieties but no tertiary amino moieties within its backbone, the corresponding polyalkylene imines are, according to the present invention, (predominantly) branched molecules containing (in respect of its backbone without consideration of any alkoxylation), in addition to the primary and/or secondary amino moieties, mandatorily tertiary amino moieties, which cause the branching of the (linear) main chain into several side chains within the polymeric backbone (basic skeleton). Polyalkylene imines, both as backbone and as alkoxylated compounds, are those compounds falling under the definition of general formula (I), wherein z is an integer of at least 1. In contrast to that, polyamines, both as backbone and as alkoxylated compounds, are those compounds of formula (I), wherein z is 0.

By consequence, the inventive alkoxylated polyalkylene imines have a basic skeleton (backbone), which comprises primary, secondary and tertiary amine nitrogen atoms which are joined by alkylene radicals R (as defined below) and are in the form of the following moieties in random arrangement:
primary amino moieties which terminate the main chain and the side chains of the basic skeleton and whose hydrogen atoms are subsequently replaced by alkylenoxy units:
   H₂N—R [symbol] and —NH₂
secondary amino moieties whose hydrogen atom is subsequently replaced by alkylenoxy units:

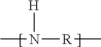

tertiary amino moieties which branch the main chain and the side chains:

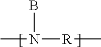

For the sake of completeness, it is indicated that the variable B indicating the branching of the polyalkylene imine backbone of compounds according to general formula (I) may contain fragments, such as —[—NH—R]_{y}—, H₂N—R or combinations thereof, including a two times, three times or even higher degree of branching. Said tertiary amino moieties are not present in the backbone of polyamine compounds. The degree of branching may be determined, for example, by NMR-spectroscopy such as ¹H-NMR or preferably ¹³C-NMR.

In order to obtain the respective alkoxylated compounds, the hydrogen atoms of the primary and/or secondary amino groups of the basic polyalkylene imine or polyamine skeleton are replaced by substituents such as those according to the formula (IIa) or (IIb) as defined below.

Within the context of the present invention, the term “polyalkylene imine backbone” relates to those fragments of the inventive alkoxylated polyalkylene imines which are not alkoxylated. The polyalkylene imine backbone is employed within the present invention as an educt in step a) to be reacted first with at least one first alkylene oxide (AO1), followed by reaction (in step c)) with at least one lactone or hydroxy carbon acid and then alkoxylated again in step c) with at least one second alkylene oxide (AO2) in order to obtain the inventive alkoxylated polyalkylene imines (“alkoxylated compounds”). Polyalkylene imines as such (backbones or not alkoxylated compounds) are known to a person skilled in the art. Examples of such types of compounds are polyethylene imines (PEI) or polypropylene imines (PPI), such as PEI 600, PEI 800 or PEI2000, which are also commercially available.

Within the context of the present invention, the term “polyamine backbone” relates to those fragments of the inventive alkoxylated polyamines which are not alkoxylated. The polyamine backbone is employed within the present invention as an educt in step a) to be reacted first with at least one first alkylene oxide (AO1), followed by reaction (in step c)) with at least one lactone or hydroxy carbon acid and then alkoxylated again in step c) with at least one second alkylene oxide (AO2) in order to obtain the inventive alkoxylated polyamines (“alkoxylated compounds”). Polyamines as such (backbones or not alkoxylated compounds) are known to a person skilled in the art.

Within the context of the present invention, the term “NH-functionality” is defined as follows: In case of (predominantly) linear amines, such as di- and oligo amines like N4 amine or hexamethylene diamine, the structure itself gives information about the content of primary, secondary and tertiary amines. A primary amino group (—NH2) has two NH-functionalities, a secondary amino group only one NH functionality, and a tertiary amino group, by consequence, has no reactive NH functionality. In case of (predominantly) branched polyethylene imines, such as those as obtained from polymerization of the monomer ethylene imine (C2H5N), the respective polymer (polyethylene imine) contains a mixture of primary, secondary and tertiary amino groups. The exact distribution of primary, secondary and tertiary amino groups can be determined as described in Lukovkin G. M., Pshezhetsky V. S., Murtazaeva G. A.: Europ. Polymer Journal 1973, 9, 559-565 and St. Pierre T., Geckle M.: ACS Polym. Prep. 1981, 22, 128-129. In case of the modification with lactone or hydroxyacids and alkylene oxides it is assumed, that polyethylene imine consist of a 1:1:1 mixture of primary, secondary and tertiary amino groups, and therefore, an amount resembling the molar mass of the monomer employed, such as ethylene imine, contributes in average with one (reactive) NH-functionality. This is the molecular weight of the repeating unit.

The invention is specified in more detail as follows:

The invention relates to an alkoxylated polyalkylene imine or alkoxylated polyamine obtainable by a process comprising the steps a) to c) as follows:
a) reaction of i) at least one polyalkylene imine or at least one polyamine with ii) at least one first alkylene oxide (AO1), wherein 0.25 to 7.0 mol, preferably 0.25 to 5.0 mol of alkylene oxide (AO1) is employed per mol of NH-functionality of polyalkylene imine or of polyamine, in order to obtain a first intermediate (I1),
b) reaction of the first intermediate (I1) with at least one lactone and/or at least one hydroxy carbon acid, wherein 0.25 to 10 mol of lactone and/or of hydroxy carbon acid is employed per mol of NH-functionality of polyalkylene imine or of polyamine (as employed in step a)), in order to obtain a second intermediate (I2),
c) reaction of the second intermediate (I2) with at least one second alkylene oxide (AO2), wherein at least 1 mol of alkylene oxide (AO2) is employed per mol of NH-functionality of polyalkylene imine or of polyamine (as employed in step a)), in order to obtain the alkoxylated polyalkylene imine or the alkoxylated polyamine.

The polyalkylene imine or the polyamine employed in step a) may be any of those compounds known to a person skilled in the art. It is preferred that the at least one polyalkylene imine or the at least one polyamine as employed in step a) is defined according to general formula (I)

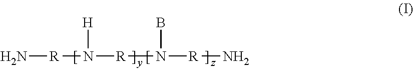

in which the variables are each defined as follows:
R represents identical or different,
   i) linear or branched C₂-C₁₂-alkylene radicals or
   ii) an etheralkyl unit of the following formula (III):

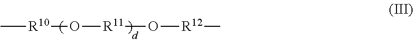

in which the variables are each defined as follows:
R¹⁰, R¹¹, R¹² represent identical or different, linear or branched C₂-C₆-alkylene radicals and
d is an integer having a value in the range of 0 to 50 or
iii) C₅-C₁a cycloalkylene radicals optionally substituted with at least one C₁-C₃ alkyl;
B represents a continuation of the polyalkylene imine by branching;
y and z are each an integer having a value in the range of 0 to 150;
preferably, R represents identical or different,
i) linear or branched C₂-C₁₂-alkylene radicals, more preferably R is ethylene, propylene or hexamethylene, or
ii) C₅-C₁₀-cycloalkylene radicals optionally substituted with at least one C₁-C₃-alkyl, more preferably R is at least one C₆-C₇-cycloalkylene radical substituted with at least one methyl or ethyl.

For the sake of completeness, it is indicated that the variable B indicating the branching of the polyalkylene imine compounds according to general formula (I) may contain fragments, such as —[—NH—R]_{y}—, H₂N—R or combinations thereof, including a two times, three times or even higher degree of branching. Said tertiary amino moieties caused by the branching of the backbone are not present within polyamine compounds according to general formula (I) since the variable z is 0 for those kind of compounds within formula (I).

In a preferred embodiment of the present invention, the alkoxylated polyalkylene imine or alkoxylated polyamine contains at least one residue according to general formula (IIa)

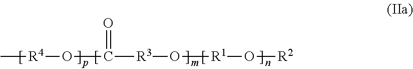

in which the variables are each defined as follows:
R¹ represents C₂-C₂₂-(1,2-alkylene) radicals;
R² represents hydrogen and/or C₁-C₂₂-alkyl and/or C₇-C₂₂-aralkyl;
R³ represents linear or branched C₁-C₂₂-alkylene radicals;
R⁴ represents C₂-C₂₂-(1,2-alkylene) radicals;
m is an integer having a value of at least 1 to 10;
n is an integer having a value of at least 5 to 100;
p is an integer having a value of at least 1 to 5;

preferably the variables within general formula (IIa) are defined as follows:
R¹ represents 1,2-ethylene, 1,2-propylene and/or 1,2-butylene, most preferably 1,2-ethylene; and/or
R² represents hydrogen and/or C₁-C₄-alkyl, preferably hydrogen, methyl and/or ethyl, most preferably hydrogen; and/or
R³ represents linear or branched C₂-C₁₀-alkylene radicals, preferably linear or branched C₂-C₅-alkylene radicals; and/or
R⁴ represents 1,2-ethylene and/or 1,2-propylene; and/or
m is an integer having a value in the range of 1 to 5, preferably of 1 to 3; and/or
n is an integer having a value in the range of 8 to 40, preferably of 10 to 25; and/or
p is 1 or 2.

In another preferred embodiment, the alkoxylated polyalkylene imine or alkoxylated polyamine contains at least one residue according to general formula (IIa)

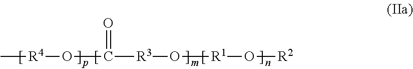

in which the variables are each defined as follows:
R¹ represents C₂-C₂₂-(1,2-alkylene) radicals;
R² represents hydrogen and/or C₁-C₂₂-alkyl and/or C₇-C₂₂-aralkyl;
R³ represents linear or branched C₁-C₂₂-alkylene radicals;
R⁴ represents C₂-C₂₂-(1,2-alkylene) radicals;
m is an integer having a value of at least 1 to 10;
n is an integer having a value of at least 5 to 100;
p is an integer having a value of at least 1 to 5;

preferably the variables within general formula (IIa) are defined as follows:
R¹ represents 1,2-ethylene, 1,2-propylene and/or 1,2-butylene, most preferably 1,2-ethylene; and/or
R² represents hydrogen and/or C₁-C₄-alkyl, preferably hydrogen, methyl and/or ethyl, most preferably hydrogen; and/or
R³ represents linear or branched C₂-C₁₀-alkylene radicals, preferably linear or branched C₂-C₅-alkylene radicals; and/or
R⁴ represents 1,2-ethylene, 1,2-propylene, 1,2 butylene and/or 1,2-pentylene, more preferably 1,2-propylene and/or 1,2-butylene;
m is an integer having a value in the range of 1 to 5, preferably of 1 to 3; and/or
n is an integer having a value in the range of 8 to 40, preferably of 10 to 25; and/or
p is 1 or 2.

In addition to the presence of at least one residue according to general formula (IIa) as described above, it is preferred that the alkoxylated polyalkylene imine or alkoxylated polyamine contains at least one residue according to general formula (IIb)

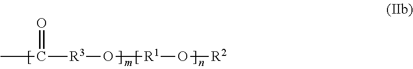

in which the variables are each defined as follows:
R¹ represents C₂-C₂₂-(1,2-alkylene) radicals;
R² represents hydrogen and/or C₁-C₂₂-alkyl and/or C₇-C₂₂-aralkyl;
R³ represents linear or branched C₁-C₂₂-alkylene radicals;
m is an integer having a value of at least 1 to 10;
n is an integer having a value of at least 5 to 100;

preferably the variables within general formula (IIb) are defined as follows:
R¹ represents 1,2-ethylene, 1,2-propylene and/or 1,2-butylene, most preferably 1,2-ethylene; and/or
R² represents hydrogen and/or C₁-C₄-alkyl, preferably hydrogen, methyl and/or ethyl, most preferably hydrogen; and/or
R³ represents linear or branched C₂-C₁₀-alkylene radicals, preferably linear or branched C₂-C₅-alkylene radicals; and/or
m is an integer having a value in the range of 1 to 5, preferably of 1 to 3; and/or
n is an integer having a value in the range of 8 to 40, preferably of 10 to 25.

In another embodiment of the present invention, it is preferred that the alkoxylated polyalkylene imine or alkoxylated polyamine contains at least one residue according to general formula (IIc)

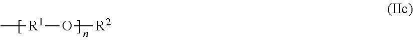

in which the variables are defined as follows:
R¹ represents C₂-C₂₂-(1,2-alkylene) radicals;
R² represents hydrogen and/or C₁-C₂₂-alkyl;
n is an integer having a value of at least 5 to 100;

preferably the variables within general formula (IIc) are defined as follows:
R¹ represents 1,2-ethylene, 1,2-propylene and/or 1,2-butylene, most preferably 1,2-ethylene; and/or
R² represents hydrogen and/or C₁-C₄-alkyl, preferably hydrogen, methyl and/or ethyl, most preferably hydrogen; and/or
n is an integer having a value in the range of 8 to 40, preferably of 10 to 25.

Another preferred embodiment relates to an alkoxylated imine or alkoxylated polyamine, wherein the residue (IIa) accounts for at least 80 wt.-%, more preferably at least 90 wt.-%, and even more preferably at last 95 wt.-% of all residues (IIa), (IIb) and (IIIc) attached to the amino groups of the polyalkylene imine or polyamine as employed in step a).

In another embodiment of the present invention, it is preferred that
i) step a) is carried out in the presence of water and/or in the presence of a base catalyst, and/or
ii) the weight average molecular weight (Mw) of the polyalkylene imine or of the polyamine employed in step a) lies in the range of 50 to 10 000 g/mol, preferably in the range of 500 to 5000 g/mol, more preferably in the range of 600 to 2 000 g/mol.

The person skilled in the art knows how to determine/measure the respective weight average molecular weight (M_{W}). This can be done, for example, by size exclusion chromatography (such as GPC). Preferably, M_{W} values are determined by the method as follows: OECD TG 118 (1996), which means in detail

OECD (1996), Test No. 118: Determination of the Number-Average Molecular Weight and the Molecular Weight Distribution of Polymers using Gel Permeation Chromatography, OECD Guidelines for the Testing of Chemicals, Section 1, OECD Publishing, Paris, also available on the internet, for example, under https://doi.org/10.1787/9789264069848-en.

Another embodiment of the present invention only relates to alkoxylated polyalkylene imines (as such) as described above, it is preferred that the variables are each defined as follows:
R is ethylene and/or propylene, preferably ethylene;
the sum of y+z is an integer having a value in the range of 9 to 120, preferably in the range of 10 to 20.

Another embodiment of the present invention only relates to alkoxylated polyamines (as such) as described above, it is preferred that
y is an integer having a value in the range of 0 to 10;
z is 0;
R represents identical or different, linear or branched C₂-C₁₂alkylene radicals or an etheralkyl unit according to formula (III), wherein
d is from 1 to 5, and
R¹⁰, R¹¹, R¹² are independently selected from linear or branched C₃ to C₄ alkylene radicals.

In another embodiment of the present invention, it is preferred that up to 100% of the nitrogen atoms present in the alkoxylated polyalkylene imine or alkoxylated polyamine are quaternized, preferably the degree of quaternization of the nitrogen atoms present in the alkoxylated polyalkylene imine or alkoxylated polyamine lies in the range of 10% to 95%.

In another embodiment of the present invention, it is preferred that
i) in step b) the lactone is caprolactone, and/or
ii) in step b) the hydroxy carbon acid is lactic acid or glycolic acid, and/or
iii) in step a) the first alkylene oxide (AO1) is at least one C₂-C₂₂-epoxide, preferably ethylene oxide and/or propylene oxide, and/or
iv) in step c) the second alkylene oxide (AO2) is at least one C₂-C₂₂-epoxide, preferably ethylene oxide or in step c) the second alkylene oxide (AO2) is at least one C₂-C₂₂-epoxide, preferably ethylene oxide or a mixture of ethylene oxide and propylene oxide.

In another embodiment of the present invention, it is preferred that
i) in step a) 0.5 to 2 mol, preferably 0.75 to 1.5 mol, of alkylene oxide (AO1) is employed per mol of NH-functionality of polyalkylene imine or of polyamine, and/or
ii) in step b) 0.5 to 3 mol, preferably 1 to 2 mol, of lactone and/or of hydroxy carbon acid is employed per mol of NH-functionality of polyalkylene imine or of polyamine (as employed in step a)), and/or
iii) in step c) 5 to 30 mol, preferably 8 to 20 mol, of alkylene oxide (AO2) is employed per mol of NH-functionality of polyalkylene imine or of polyamine (as employed in step a)).

The inventive alkoxylated polyalkylene imines or alkoxylated polyamines may also be quaternized. A suitable degree of quaternization is up to 100%, in particular from 10 to 95%. The quaternization is effected preferably by introducing C₁-C₂₂-alkyl groups, C₁-C₄-alkyl groups and/or C₇-C₂₂-aralkyl groups and may be undertaken in a customary manner by reaction with corresponding alkyl halides and dialkyl sulfates.

The quaternization may be advantageous in order to adjust the alkoxylated polyalkylene imines or the alkoxylated polyamines to the particular composition such as cosmetic compositions in which they are to be used, and to achieve better compatibility and/or phase stability of the formulation.

The quaternization of alkoxylated polyalkylene imines or alkoxylated polyamines is achieved preferably by introducing C₁-C₂₂ alkyl, C₁-C₄-alkyl groups and/or C₇-C₂₂ aralkyl, aryl or alkylaryl groups and may be undertaken in a customary manner by reaction with corresponding alkyl-, aralkyl-halides and dialkylsulfates, as described for example in WO 09/060059.

Quaternization can be accomplished, for example, by reacting an alkoxylated polyamine or alkoxylated polyalkylene imine with an alkylation agent such as a C₁-C₄-alkyl halide, for example with methyl bromide, methyl chloride, ethyl chloride, methyl iodide, n-butyl bromide, isopropyl bromide, or with an aralkyl halide, for example with benzyl chloride, benzyl bromide or with a di-C₁-C₂₂-alkyl sulfate in the presence of a base, especially with dimethyl sulfate or with diethyl sulfate. Suitable bases are, for example, sodium hydroxide and potassium hydroxide.

The amount of alkylating agent determines the amount of quaternization of the amino groups in the polymer, i.e. the amount of quaternized moieties.

The amount of the quaternized moieties can be calculated from the difference of the amine number in the non-quaternized amine and the quaternized amine.

The amine number can be determined according to the method described in DIN 16945.

The quaternization can be carried out without any solvent. However, a solvent or diluent like water, acetonitrile, dimethylsulfoxide, N-methylpyrrolidone, etc. may be used. The reaction temperature is usually in the range from 10° C. to 150° C. and is preferably from 50° C. to 100° C.

Another subject of the present invention is a process for preparing the alkoxylated polyalkylene imines or the alkoxylated polyamines as described above. In the following the steps a) to c) (as described above) are described in more detail. The below information also applies to the above described polymer as such obtainable by the respective process. Within this process, a polyalkylene imine (as such) or a polyamine (as such) is according to step a) first reacted with at least one first alkylene oxide (AO1), followed in step b) by reaction of the respective intermediate (I1) with at least one lactone and/or at least one hydroxy carbon acid and then (in step c)) followed by reaction with at least one C₂-C₂₂-epoxide in order to obtain the respective alkoxylated compounds. In case two or more alkylene oxides are employed in steps a) and/or c), the respective alkoxylated compounds may contain either a random orientation of the respective alkylene oxide fragments or a block orientation.

It has to be noted that the alkoxylation process as such, wherein polyalkylene imines or polyamines are reacted with at least one alkylene oxide according to step a), such as ethylene oxide or propylene oxide, is known to a person skilled in the art. Step a) can be carried out in the presence of water, with or without the presence of a catalyst. In case more than one equivalent of alkylene oxide is employed, step a) is preferably carried out in the absence of any water, but in the presence of at least one catalyst. It is also preferred that in case more than one equivalent of alkylene oxide is employed in step a), step a) is carried out as a two-step reaction as described in further detail below, wherein the first step is carried out in the presence of water and the second step is carried out without any water, but in the presence of a catalyst.

The same methods can be applied for the present invention within step c), wherein the respective intermediates (I2) are obtained by reaction with a first alkylene oxide and afterwards with lactones or hydroxyl carbon acids, undergo the second alkylation process afterwards. However, step c) is usually carried out in the absence of any water, but in the presence of at least one catalyst.

The conversion rates of the respective steps can be determined according to methods known to the skilled person, such as NMR-spectroscopy. For example, both the first reaction step, the second reaction step and/or the third reaction step may be monitored by ¹³C-NMR-spectroscopy and/or ¹H-NMR-spectroscopy.

In connection with the second step b) of the method according to the present invention for preparing an alkoxylated polyalkylene imine or an alkoxylated polyamine, the respective intermediate (I1) as obtained in step a) is reacted with at least one lactone and/or at least one hydroxycarbon acid. This second reaction step as such is known to a person skilled in the art.

However, it is preferred within this second reaction step b) that the reaction temperature is in a range between 50 to 200° C., more preferred between 70 to 180° C., most preferred in a range between 100 to 160° C.

This second reaction step b) may be carried out in the presence of at least one solvent and/or at least one catalyst. However, it is preferred within the second reaction step b) that the respective step is carried out without any solvent and/or without any catalyst. Suitable solvents are preferably selected from xylene, toluene, tetrahydrofuran (THF), methyl-tert. butyl ether or diethyl ether. Preferred catalysts are selected from alkali metal hydroxides or alkali metal alkoxides, such as KOMe, NaOMe or Sn-octanoate.

As described above, the first and/or the third reaction step (steps a) and c)) of the method according to the present invention as such (alkoxylation) is known to a person skilled in the art. The alkoxylation as such (first and third reaction step of the method according to the present invention) may independently from each other be carried out as a one-step reaction or the alkoxylation as such may be split into two or more individual steps.

It is preferred within the present invention that respective step (alkoxylation) is carried out as a single step reaction.

Within this preferred embodiment, the alkoxylation is carried out in the presence of at least one catalyst and/or in the absence of water. Within this single step reaction of the alkoxylation step, the catalyst is preferably a basic catalyst. Examples of suitable catalysts are alkali metal and alkaline earth metal hydroxides such as sodium hydroxide, potassium hydroxide and calcium hydroxide, alkali metal alkoxides, in particular sodium and potassium C₁-C₄-alkoxides, such as sodium methoxide, sodium ethoxide and potassium tert-butoxide, alkali metal and alkaline earth metal hydrides such as sodium hydride and calcium hydride, and alkali metal carbonates such as sodium carbonate and potassium carbonate. Preference is given to the alkali metal hydroxides and the alkali metal alkoxides, particular preference being given to potassium hydroxide and sodium hydroxide. Typical use amounts for the base are from 0.05 to 10% by weight, in particular from 0.5 to 2% by weight, based on the total amount of polyalkylene imine or polyamine and alkylene oxide.

One alternative procedure in connection with the reaction step a) (alkoxylation) is a two-step reaction by initially undertaking only an incipient alkoxylation polyalkylene imine or the polyamine. In this first part of the step a), the polyalkylene imine or of the polyamine is reacted only with a portion of the total amount of alkylene oxide used, which corresponds to about 1 mole of alkylene oxide per mole of NH moiety or NH functionality, respectively. This reaction (of the first part of the step a)) is undertaken generally in the absence of a catalyst in aqueous solution at from 70 to 200° C., preferably from 80 to 160° C., under a pressure of up to 10 bar, in particular up to 8 bar.

Said second part of the alkoxylation reaction (step a)) of the alternative method according to the present invention) is undertaken typically in the presence of the same type of catalyst as described above for the single step alkoxylation reaction.

The second step of alkoxylation (step c) may be undertaken in substance (variant a)) or in an organic solvent (variant b)). The process conditions specified below may be used for both steps of the alkoxylation reaction.

In variant a), the aqueous solution of the incipiently alkoxylated polyalkylene imine or polyamine obtained in the first step, after addition of the catalyst, is initially dewatered. This can be done in a simple manner by heating to from 80 to 150° C. and distilling off the water under a reduced pressure of from less than 30 mbar. The subsequent reactions with the alkylene oxides are effected typically at from 70 to 200° C., preferably from 100 to 180° C., and at a pressure of up to 10 bar, in particular up to 8 bar, and a continued stirring time of from about 0.5 to 4 h at from about 100 to 160° C. and constant pressure follows in each case.

Suitable reaction media for variant b) are in particular nonpolar and polar aprotic organic solvents. Examples of particularly suitable nonpolar aprotic solvents include aliphatic and aromatic hydrocarbons such as hexane, cyclohexane, toluene and xylene. Examples of particularly suitable polar aprotic solvents are ethers, in particular cyclic ethers such as tetrahydrofuran and dioxane, N,N-dialkylamides such as dimethylformamide and dimethylacetamide, and N-alkyllactams such as N-methylpyrrolidone. It is of course also possible to use mixtures of these aprotic solvents. Preferred solvents are xylene and toluene.

In variant b) too, the solution obtained in the first step, after addition of catalyst and solvent, is initially dewatered, which is advantageously done by separating out the water at a temperature of from 120 to 180° C., preferably supported by a gentle nitrogen stream. The subsequent reaction with the alkylene oxide may be effected as in variant a).

In variant a), the alkoxylated polyalkylene imine or polyamine is obtained directly in substance and may be converted if desired to an aqueous solution. In variant b), the organic solvent is typically removed and replaced by water. The products may of course also be isolated in substance.

The amount of residues according to, for example, formula (IIa), formula (IIb) and/or formula (IIc) can be controlled by several factors, such as the stoichiometry of the educts employed, the reaction temperature within the individual steps, the amount and/or type of the catalysts employed and/or the selected solvent.

In a more preferred embodiment of this invention, the alkoxylated polyalkylene imine or alkoxylated polyamine as detailed before and hereinafter comprises at least 80 wt.-%, more preferably at least 90 wt.-%, even more preferably at least 95 wt.-% of residue (IIa), based on the total amount of all residues (IIa), (IIb) and (IIc) attached to the amino groups of the polyalkylene imine or the polyamine as employed in step a) for preparing the inventive compounds.

In another embodiment, the alkoxylated polyalkylene imine or alkoxylated polyamine can—if desired—be converted to solid polymer, for example pourable polymer, by drying following polymerization and optional post-treatment. Drying methods are known to a person skilled in the art.

The drying can take place, for example, by spray drying, drum drying or another warm air or contact heat drying. Drying by means of vacuum drying or freeze drying is also possible. All other methods for drying are in principle likewise suitable. Drying methods with spraying such as spray drying and by means of contact surfaces such as drum drying are preferred methods. Spray drying by spraying into a hot gas or hot air is more preferable.

A person skilled in the art is very familiar with optimizing the particular polymer solutions or dispersions by optimizing for instance the solids content to the method of drying to be used.

However, it is also possible to dispense with drying, for example of polymer solutions or dispersions are desired.

Drying under protective gas is possible and further improves the result of the treatment.

Another subject matter of the present invention is the use of the above-mentioned alkoxylated polyalkylene imines or alkoxylated polyamines in fabric and home care products, in cosmetic formulations, as crude oil emulsion breaker, in pigment dispersions for inkjet inks, in formulations for electro plating, in cementitious compositions and/or as dispersant for agrochemical formulations, preferably in cleaning compositions and/or in fabric and home care products, in particular cleaning compositions for clay removal.

The inventive alkoxylated polyalkylene imines or alkoxylated polyamines can be added to cosmetic formulations, as crude oil emulsion breaker, in pigment dispersions for ink jet inks, formulations for electro plating, in cementitious compositions. However, the inventive compounds can also be added to (used in) washing or cleaning compositions.

Another subject-matter of the present invention is, therefore, a cleaning composition, fabric and home care product, comprising at least one polymer of the present invention, as defined above, preferably a cleaning composition and/or fabric and home care product, comprising at least one polymer of the present invention, and in particular a cleaning composition for removal, dispersion and/or emulsification of soils and/or modification of treated surfaces and/or whiteness maintenance of treated surfaces, preferably at least two of those, more preferably at least three of those, and even more preferably four or more of those advantages.

Furthermore, the present invention also relates to a cosmetic formulation, crude oil emulsion breaker, pigment dispersion for ink jet inks, formulation for electro plating, cementitious composition and/or dispersant for agrochemical formulations, comprising at least one alkoxylated polyalkylene imine or alkoxylated polyamine, as defined above.

Cleaning compositions are preferably
i) for clay removal, and/or
ii) soil removal of particulate stains, and/or
iii) dispersion and/or emulsification of soils, and/or
iv) modification of treated surface to improve removal upon later re-soiling, and/or
v) whiteness improvement and/or
vi)—when at least one enzyme selected from the list consisting of lipases, hydrolases, amylases, proteases, cellulases, hemicellulases, phospholipases, esterases, pectinases, lactases and peroxidases, and combinations of at least two of the foregoing types, is present—additionally for improvement of oily/fatty stains, food stain removal and/or removal of complex stains, and/or
vii) additionally comprising at least one enzyme selected from lipases, hydrolases, amylases, proteases, cellulases, hemicellulases, phospholipases, esterases, pectinases, lactases and peroxidases, and combinations of at least two of the foregoing types, and/or
viii) for oily/fatty stain removal, food stain removal and/or removal of complex stains, when at least one enzyme according to vii) is present.

The inventive polymer(s) are present in said cleaning compositions and formulations at a concentration of 0.1 to 15 weight %, preferably at a concentration of 0.5 to 5 weight %.

The inventive polymer(s) can also be added to a cleaning composition and formulation comprising from about 1% to about 70% by weight of a surfactant system. The inventive polymer(s) may be present in a cleaning composition at a concentration of from about 0.1% to about 5% by weight of the composition, or at a concentration of from about 0.5% to about 2% by weight of the composition.

Preferably, the inventive composition is a laundry detergent, a cleaning composition and/or fabric and home care product, preferably is a laundry detergent composition, comprising at least one inventive polymer, providing improved removal, dispersion and/or emulsification of soils and/or modification of treated surfaces and/or whiteness maintenance of treated surfaces.

At least one inventive polymer as described herein is present in said inventive cleaning compositions at a concentration of 0.05 to 20 weight %, preferably from about 0.05% to 15%, more preferably from about 0.1% to about 10%, and most preferably from about 0.5% to about 5%, in relation to the total weight of such composition or product.

In one preferred embodiment, the cleaning composition of the present invention is a liquid or solid laundry detergent composition.

In another embodiment, the cleaning composition of the present invention is a hard surface cleaning composition that may be used for cleaning various surfaces such as hard wood, tile, ceramic, plastic, leather, metal, glass, and includes the use of dish ware and cutlery and the like, such as the use in manual and automated dish wash applications.

In another embodiment, the cleaning composition is designed to be used in a personal care and pet care compositions such as shampoo composition, body wash, liquid or solid soap.

In one embodiment of the present invention, the inventive polymer may be used for
i) clay removal, and/or
ii) soil removal of particulate stains, and/or
iii) dispersion and/or emulsification of soils, and/or
iv) modification of treated surface to improve removal upon later re-soiling, and/or
v) whiteness improvement and/or
vi)—when at least one enzyme selected from the list consisting of lipases, hydrolases, amylases, proteases, cellulases, hemicellulases, phospholipases, esterases, pectinases, lactases and peroxidases, and combinations of at least two of the foregoing types, is present—additionally for improvement of oily/fatty stains, food stain removal and/or removal of complex stains, each of the before mentioned options i) to vi) preferably for use in laundry care compositions and more preferably in a laundry detergent composition.

In one embodiment the inventive polymers of the present invention may be utilized in cleaning compositions comprising a surfactant system comprising C10-C15 alkyl benzene sulfonates (LAS) as the primary surfactant and one or more co-surfactants selected from nonionic, cationic, other anionic surfactants or mixtures thereof.

In a further embodiment the inventive polymers of the present invention may be utilized in cleaning compositions, such as laundry detergents of any kind, and the like, comprising C8-C18 linear or branched alkyl ethersulfate with 3-10 ethylenoxy-units as the primary surfactant and one or more co-surfactants selected from nonionic, cationic, other anionic surfactants or mixtures thereof.

In a further embodiment the inventive polymers of the present invention may be utilized in cleaning compositions, such as laundry detergents of any kind, and the like, comprising C10-C18 alkyl ethoxylate surfactant as the primary surfactant and one or more co-surfactants selected from other nonionic, cationic, anionic surfactants or mixtures thereof.

The selection of co-surfactants in these embodiments may be dependent upon the application and the desired benefit.

In one embodiment of the present invention, the polymer according to the invention is a component of a cleaning composition, such as preferably a laundry formulation and more preferably of a so-called laundry care composition, or a dish wash composition, that each additionally comprise at least one surfactant, preferably at least one anionic surfactant.

In one embodiment of the present invention, the polymer according to the invention is a component of a cleaning composition, such as preferably a laundry formulation and more preferably of a so-called laundry care composition, or a dish wash composition, that each additionally comprise at least one enzyme, preferably selected from one or more lipases, hydrolases, amylases, proteases, cellulases, hemicellulases, phospholipases, esterases, pectinases, lactases and peroxidases, and combinations of at least two of the foregoing types.

Formulations according to the invention may comprise at least one additional surfactant, selected from semi-polar nonionic surfactants and from zwitterionic surfactants:

Description of Cleaning Compositions, Formulations and their Ingredients

The phrase “cleaning composition” as used herein includes compositions and formulations designed for cleaning soiled material. Such compositions and formulations include those designed for cleaning soiled material or surfaces of any kind.

Compositions for “industrial and institutional cleaning” includes such cleaning compositions being designed for use in industrial and institutional cleaning, such as those for use of cleaning soiled material or surfaces of any kind, such as hard surface cleaners for surfaces of any kind, including tiles, carpets, PVC-surfaces, wooden surfaces, metal surfaces, lacquered surfaces.

“Compositions for Fabric and Home Care” include cleaning compositions including but not limited to laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation, preferably during the wash cycle of the laundering or dish washing operation.

The cleaning compositions of the invention may be in any form, namely, in the form of a liquid; a solid such as a powder, granules, agglomerate, paste, tablet, pouches, bar, gel; an emulsion; types delivered in dual- or multi-compartment containers; single-phase or multi-phase unit dose; a spray or foam detergent; premoistened wipes (i.e., the cleaning composition in combination with a nonwoven material such as that discussed in U.S. Pat. No. 6,121,165, Mackey, et al.); dry wipes (i.e., the cleaning composition in combination with a nonwoven materials, such as that discussed in U.S. Pat. No. 5,980,931, Fowler, et al.) activated with water by a user or consumer; and other homogeneous, non-homogeneous or single-phase or multiphase cleaning product forms.

The liquid cleaning compositions of the present invention preferably have a viscosity of from 50 to 4000 mPa*s; liquid dish wash cleaning compositions (also liquid “dish wash compositions”) have a viscosity of preferably from 100 to 2000 mPa*s, and most preferably from 500 to 1500 mPa*s at 20 1/s and 20° C.; liquid laundry cleaning compositions have a viscosity of preferably from 50 to 2000 mPa*s, more preferably from 50 to 1000 mPa*s and most preferably from 50 to 500 mPa*s at 20 1/s and 20° C.

Cleaning compositions such as laundry detergents, fabric and home care products, dish wash compositions, and formulations for industrial and institutional cleaning as such are known to a person skilled in the art. Any composition etc. known to a person skilled in the art, in connection with the respective use, can be employed within the context of the present invention by including at least one inventive polymer, preferably at least one polymer in amounts suitable for expressing a certain property within such composition, especially when such composition is used in its area of use.

The cleaning compositions of the invention may—and preferably do—contain adjunct cleaning additives (also abbreviated herein as “adjuncts”), such adjuncts being preferably in addition to a surfactant system as defined before.

Suitable adjunct cleaning additives include builders, cobuilders, structurants or thickeners, clay soil removal/anti-redeposition agents, polymeric soil release agents, dispersants such as polymeric dispersing agents, polymeric grease cleaning agents, solubilizing agents, chelating agents, enzymes, enzyme stabilizing systems, bleaching compounds, bleaching agents, bleach activators, bleach catalysts, brighteners, malodor control agents, pigments, dyes, opacifiers, hueing agents, dye transfer inhibiting agents, chelating agents, suds boosters, suds suppressors (antifoams), color speckles, silver care, anti-tarnish and/or anti-corrosion agents, alkalinity sources, pH adjusters, pH-buffer agents, hydrotropes, scrubbing particles, antibacterial agents, anti-oxidants, softeners, carriers, processing aids, pro-perfumes, and perfumes.

Liquid cleaning compositions additionally may comprise—and preferably do comprise at least one of—rheology control/modifying agents, emollients, humectants, skin rejuvenating actives, and solvents.

Solid compositions additionally may comprise—and preferably do comprise at least one of—fillers, bleaches, bleach activators and catalytic materials.

Suitable examples of such cleaning adjuncts and levels of use are found in WO 99/05242, U.S. Pat. Nos. 5,576,282, 6,306,812 B1 and 6,326,348 B1.

Those of ordinary skill in the art will understand that a detersive surfactant encompasses any surfactant or mixture of surfactants that provide cleaning, stain removing, or laundering benefit to soiled material.

Hence, the cleaning compositions of the invention such as laundry detergents, fabric and home care products, and formulations for industrial and institutional cleaning preferably additionally comprise a surfactant system and, more preferably, also further adjuncts, as the one described above and below in more detail.

The surfactant system may be composed from one surfactant or from a combination of surfactants selected from anionic surfactants, nonionic surfactants, cationic surfactants, zwitterionic surfactants, amphoteric surfactants, ampholytic surfactants, and mixtures thereof. Those of ordinary skill in the art will understand that a surfactant system for detergents encompasses any surfactant or mixture of surfactants that provide cleaning, stain removing, or laundering benefit to soiled material.

The cleaning compositions of the invention preferably comprise a surfactant system in an amount sufficient to provide desired cleaning properties. In some embodiments, the cleaning composition comprises, by weight of the composition, from about 1% to about 70% of a surfactant system. In other embodiments, the liquid cleaning composition comprises, by weight of the composition, from about 2% to about 60% of the surfactant system. In further embodiments, the cleaning composition comprises, by weight of the composition, from about 5% to about 30% of the surfactant system. The surfactant system may comprise a detersive surfactant selected from anionic surfactants, nonionic surfactants, cationic surfactants, zwitterionic surfactants, amphoteric surfactants, ampholytic surfactants, and mixtures thereof.

Nonlimiting examples of anionic surfactants—which may be employed also as co-surfactants in combinations of more than one surfactant—useful herein include: C9-C20 linear alkylbenzenesulfonates (LAS), C10-C20 primary, branched chain and random alkyl sulfates (AS); C10-C18 secondary (2,3) alkyl sulfates; C10-C18 alkyl alkoxy sulfates (AExS) wherein x is from 1 to 30; C10-C18 alkyl alkoxy carboxylates comprising 1 to 5 ethoxy units; mid-chain branched alkyl sulfates as discussed in U.S. Pat. Nos. 6,020,303 and 6,060,443; mid-chain branched alkyl alkoxy sulfates as discussed in U.S. Pat. Nos. 6,008,181 and 6,020,303; modified alkylbenzene sulfonate (MLAS) as discussed in WO 99/05243, WO 99/05242 and WO 99/05244; methyl ester sulfonate (MES); and alpha-olefin sulfonate (AOS).

Preferred anionic surfactants are C10-C15 linear alkylbenzenesulfonates, C10-C18 alkylethersulfates with 1-5 ethylenoxy units and C10-C18 alkylsulfates.

In Laundry formulations anionic surfactants contribute usually by far the largest share of surfactants within such formulation. Hence, preferably, the inventive cleaning compositions for use in laundry comprise at least one anionic surfactant and optionally further surfactants selected from any of the surfactants classes described herein, preferably from non-ionic surfactants and/or non-ionic amphoteric surfactants.

Non-limiting examples of nonionic surfactants—which may be employed also as co-surfactants in combinations of more than one other surfactant—include: C8-C18 alkyl ethoxylates, such as, NEODOL® nonionic surfactants from Shell; ethylenoxide/propylenoxide block alkoxylates as PLURONIC® from BASF; C₁₄-C₂₂ mid-chain branched alkyl alkoxylates, BAEx, wherein x is from 1 to 30, as discussed in U.S. Pat. Nos. 6,153,577, 6,020,303 and 6,093,856; alkylpolysaccharides as discussed in U.S. Pat. No. 4,565,647 Llenado, issued Jan. 26, 1986; specifically alkylpolyglycosides as discussed in U.S. Pat. Nos. 4,483,780 and 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408.

Preferred nonionic surfactants are C12/14 and C16/18 fatty alkoholalkoxylates, C13/15 oxoalkoholalkoxylates, C13-alkoholalkoxylates, and 2-propylheptylalkoholalkoxylates with 3-15 ethoxy units or with 1-3 propoxy- and 2-15 ethoxy units.

Preferred non-ionic surfactants are alkoxylated alcohols and alkoxylated fatty alcohols, di- and multiblock copolymers of ethylene oxide and propylene oxide and reaction products of sorbitan with ethylene oxide or propylene oxide, furthermore alkylphenol ethoxylates, alkyl glycosides, polyhydroxy fatty acid amides (glucamides). Examples of (additional) amphoteric surfactants are so-called amine oxides.

Preferred examples of alkoxylated alcohols and alkoxylated fatty alcohols are, for example, compounds of the general formula (A)

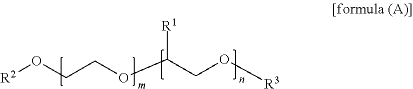

in which the variables are defined as follows:
R1 is selected from linear C₁-C₁₀-alkyl, preferably ethyl and particularly preferably methyl,
R2 is selected from C₈-C₂₂-alkyl, for example n-C8H17, n-C10H21, n-C12H25, n-C14H29, n-C16H33 or n-C18H37,
R3 is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,
m and n are in the range from zero to 300, where the sum of n and m is at least one. Preferably, m is in the range from 1 to 100 and n is in the range from 0 to 30.

Here, compounds of the general formula (A) may be block copolymers or random copolymers, preference being given to block copolymers.

Other preferred examples of alkoxylated alcohols and alkoxylated fatty alcohols are, for example, compounds of the general formula (B)

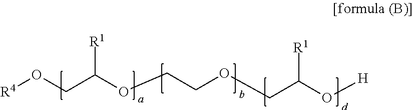

in which the variables are defined as follows:
R¹ is identical or different and selected from linear C₁-C₄-alkyl, preferably identical in each case and ethyl and particularly preferably methyl,
R⁴ is selected from C₆-C₂₀-alkyl, in particular n-C₈H₁₇, n-C₁₀H₂₁, n-C₁₂H₂₅, n-C₁₄H₂₉, n-C₁₆H₃₃, n-C₁₈H₃₇,
a is a number in the range from zero to 6, preferably 1 to 6,
b is a number in the range from zero to 20, preferably 4 to 20,
d is a number in the range from 4 to 25.

Preferably, at least one of a and b is greater than zero.

Here, compounds of the general formula (B) may be block copolymers or random copolymers, preference being given to block copolymers.

Further suitable non-ionic surfactants are selected from di- and multiblock copolymers, composed of ethylene oxide and propylene oxide. Further suitable non-ionic surfactants are selected from ethoxylated or propoxylated sorbitan esters. Alkylphenol ethoxylates or alkyl polyglycosides or polyhydroxy fatty acid amides (glucamides) are likewise suitable. An overview of suitable further non-ionic surfactants can be found in EP-A 0 851 023 and in DE-A 198 19 187.

Mixtures of two or more different non-ionic surfactants may of course also be present.

Non-limiting examples of semi-polar nonionic surfactants (also amphoteric surfactants) include: water-soluble amine oxides containing one alkyl moiety of from about 8 to about 18 carbon atoms and 2 moieties selected from the group consisting of alkyl moieties and hydroxyalkyl moieties containing from about 1 to about 3 carbon atoms; and water-soluble sulfoxides containing one alkyl moiety of from about 10 to about 18 carbon atoms and a moiety selected from the group consisting of alkyl moieties and hydroxyalkyl moieties of from about 1 to about 3 carbon atoms. See WO 01/32816, U.S. Pat. Nos. 4,681,704, and 4,133,779. Suitable surfactants include thus so-called amine oxides, such as lauryl dimethyl amine oxide (“lauramine oxide”).

Preferred semi-polar nonionic (co-)surfactants are C₈-C₁₈ alkyl-dimethyl aminoxides and C₈-C₁₈ alkyl-di(hydroxyethyl)aminoxide.

Non-limiting examples of cationic co-surfactants include: the quaternary ammonium surfactants, which can have up to 26 carbon atoms include: alkoxylated quaternary ammonium (AQA) surfactants as discussed in U.S. Pat. No. 6,136,769; dimethyl hydroxyethyl quaternary ammonium as discussed in U.S. Pat. No. 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine (APA).

Examples of suitable anionic surfactants are alkali metal and ammonium salts of C₈-C₁₂-alkyl sulfates, of C₁₂-C₁₈-fatty alcohol ether sulfates, of C₁₂-C₁₈-fatty alcohol polyether sulfates, of sulfuric acid half-esters of ethoxylated C₄-C₁₂-alkylphenols (ethoxylation: 3 to 50 mol of ethylene oxide/mol), of C₁₂-C₁₈-alkylsulfonic acids, of C₁₂-C₁₈ sulfo fatty acid alkyl esters, for example of C₁₂-C₁₈ sulfo fatty acid methyl esters, of C₁₀-C₁₈-alkylarylsulfonic acids, preferably of n-C₁₀-C₁₈-alkylbenzene sulfonic acids, of C₁₀-C₁₈ alkyl alkoxy carboxylates and of soaps such as for example C₈-C₂₄-carboxylic acids. Preference is given to the alkali metal salts of the aforementioned compounds, particularly preferably the sodium salts.

In one embodiment of the present invention, anionic surfactants are selected from n-C₁₀-C₁₈-alkylbenzene sulfonic acids and from fatty alcohol polyether sulfates, which, within the context of the present invention, are in particular sulfuric acid half-esters of ethoxylated C₁₂-C₁₈-alkanols (ethoxylation: 1 to 50 mol of ethylene oxide/mol), preferably of n-C₁₂-C₁₈-alkanols.

In one embodiment of the present invention, also alcohol polyether sulfates derived from branched (i.e. synthetic) C₁₁-C₁₈-alkanols (ethoxylation: 1 to 50 mol of ethylene oxide/mol) may be employed.

Preferably, the alkoxylation group of both types of alkoxylated alkyl sulfates, based on C₁₂-C₁₈-fatty alcohols or based on branched (i.e. synthetic) C₁₁-C₁₈-alcohols, is an ethoxylation group and an average ethoxylation degree of any of the alkoxylated alkyl sulfates is 1 to 5, preferably 1 to 3.

Preferably, the laundry detergent formulation of the present invention comprises from at least 1 wt % to 50 wt %, preferably in the range from greater than or equal to about 2 wt % to equal to or less than about 30 wt %, more preferably in the range from greater than or equal to 3 wt % to less than or equal to 25 wt %, and most preferably in the range from greater than or equal to 5 wt % to less than or equal to 25 wt % of one or more anionic surfactants as described above, based on the particular overall composition, including other components and water and/or solvents.

Cleaning compositions may also contain zwitterionic surfactants. Examples of zwitterionic surfactants are C₁₂-C₁₈-alkylbetaines and sulfobetaines.

Compositions according to the invention may comprise at least one builder. In the context of the present invention, no distinction will be made between builders and such components elsewhere called “co-builders”. Examples of builders are complexing agents, hereinafter also referred to as complexing agents, ion exchange compounds, and precipitating agents. Builders are selected from citrate, phosphates, silicates, carbonates, phosphonates, amino carboxylates and polycarboxylates.

In the context of the present invention, the term citrate includes the mono- and the dialkali metal salts and in particular the mono- and preferably the trisodium salt of citric acid, ammonium or substituted ammonium salts of citric acid as well as citric acid. Citrate can be used as the anhydrous compound or as the hydrate, for example as sodium citrate dihydrate. Quantities of citrate are calculated referring to anhydrous trisodium citrate.

The term phosphate includes sodium metaphosphate, sodium orthophosphate, sodium hydrogenphosphate, sodium pyrophosphate and polyphosphates such as sodium tripolyphosphate. Preferably, however, the composition according to the invention is free from phosphates and polyphosphates, with hydrogenphosphates being subsumed, for example free from trisodium phosphate, pentasodium tripolyphosphate and hexasodium metaphosphate (“phosphate-free”). In connection with phosphates and polyphosphates, “free from” should be understood within the context of the present invention as meaning that the content of phosphate and polyphosphate is in total in the range from 10 ppm to 0.2% by weight of the respective composition, determined by gravimetry.

The term carbonates includes alkali metal carbonates and alkali metal hydrogen carbonates, preferred are the sodium salts. Particularly preferred is Na₂CO₃.

Examples of phosphonates are hydroxyalkanephosphonates and aminoalkane-phosphonates. Among the hydroxyalkanephosphonates, the 1-hydroxyethane-1,1-diphosphonate (HEDP) is of particular importance as builder. It is preferably used as sodium salt, the disodium salt being neutral and the tetrasodium salt being alkaline (pH 9). Suitable aminoalkanephosphonates are preferably ethylene diaminetetramethylene-phosphonate (EDTMP), diethylenetriaminepentamethylenephosphonate (DTPMP), and also their higher homologues. They are preferably used in the form of the neutrally reacting sodium salts, e.g. as hexasodium salt of EDTMP or as hepta- and octa-sodium salts of DTPMP.

Examples of amino carboxylates and polycarboxylates are nitrilotriacetates, ethylene diamine tetraacetate, diethylene triamine pentaacetate, triethylene tetraamine hexaacetate, propylene diamines tetraacetic acid, ethanol-diglycines, methylglycine diacetate, and glutamine diacetate. The term amino carboxylates and polycarboxylates also include their respective non-substituted or substituted ammonium salts and the alkali metal salts such as the sodium salts, in particular of the respective fully neutralized compound.

Silicates in the context of the present invention include in particular sodium disilicate and sodium metasilicate, alumosilicates such as for example zeolites and sheet silicates, in particular those of the formula α-Na₂Si₂O₅, β-Na₂Si₂O₅, and δ-Na₂Si₂O₅.

Compositions according to the invention may contain one or more builder selected from materials not being mentioned above. Examples of builders are α-hydroxypropionic acid and oxidized starch.

In one embodiment of the present invention, builder is selected from polycarboxylates. The term “polycarboxylates” includes non-polymeric polycarboxylates such as succinic acid, C₂-C₁₆-alkyl disuccinates, C₂-C₁₆-alkenyl disuccinates, ethylene diamine N,N′-disuccinic acid, tartaric acid diacetate, alkali metal malonates, tartaric acid monoacetate, propanetricarboxylic acid, butanetetracarboxylic acid and cyclopentanetetracarboxylic acid.

Oligomeric or polymeric polycarboxylates are for example polyaspartic acid or in particular alkali metal salts of (meth)acrylic acid homopolymers or (meth)acrylic acid copolymers.

Suitable co-monomers are monoethylenically unsaturated dicarboxylic acids such as maleic acid, fumaric acid, maleic anhydride, itaconic acid and citraconic acid. A suitable polymer is in particular polyacrylic acid, which preferably has a weight-average molecular weight M_{w} in the range from 2000 to 40 000 g/mol, preferably 2000 to 10 000 g/mol, in particular 3000 to 8000 g/mol. Further suitable copolymeric polycarboxylates are in particular those of acrylic acid with methacrylic acid and of acrylic acid or methacrylic acid with maleic acid and/or fumaric acid.

It is also possible to use copolymers of at least one monomer from the group consisting of monoethylenically unsaturated C₃-C₁₀-mono- or C₄-C₁₀-dicarboxylic acids or anhydrides thereof, such as maleic acid, maleic anhydride, acrylic acid, methacrylic acid, fumaric acid, itaconic acid and citraconic acid, with at least one hydrophilically or hydrophobically modified co-monomer as listed below.

Suitable hydrophobic co-monomers are, for example, isobutene, diisobutene, butene, pentene, hexene and styrene, olefins with ten or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C₂₂-α-olefin, a mixture of C₂₀-C₂₄-α-olefins and polyisobutene having on average 12 to 100 carbon atoms per molecule.

Suitable hydrophilic co-monomers are monomers with sulfonate or phosphonate groups, and also non-ionic monomers with hydroxyl function or alkylene oxide groups. By way of example, mention may be made of: allyl alcohol, isoprenol, methoxypolyethylene glycol (meth)acrylate, methoxypolypropylene glycol (meth)acrylate, methoxypolybutylene glycol (meth)acrylate, methoxypoly(propylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide) (meth)acrylate. Polyalkylene glycols here can comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

Moreover, amphoteric polymers can also be used as builders.

Compositions according to the invention can comprise, for example, in the range from in total 0.1 to 70% by weight, preferably 10 to 50% by weight, preferably up to 20% by weight, of builder(s), especially in the case of solid formulations. Liquid formulations according to the invention preferably comprise in the range of from 0.1 to 8% by weight of builder.

Formulations according to the invention can comprise one or more alkali carriers. Alkali carriers ensure, for example, a pH of at least 9 if an alkaline pH is desired. Of suitability are, for example, the alkali metal carbonates, the alkali metal hydrogen carbonates, and alkali metal metasilicates mentioned above, and, additionally, alkali metal hydroxides. A preferred alkali metal is in each case potassium, particular preference being given to sodium. In one embodiment of the present invention, a pH >7 is adjusted by using amines, preferably alkanolamines, more preferably triethanolamine.

Compositions according to the invention can comprise one or more enzymes. Useful enzymes are, for example, one or more hydrolases selected from lipases, amylases, proteases, cellulases, hemicellulases, phospholipases, esterases, pectinases, lactases and peroxidases, and combinations of at least two of the foregoing types.

Such enzyme(s) can be incorporated at levels sufficient to provide an effective amount for cleaning. The preferred amount is in the range from 0.001% to 5% of active enzyme by weight in the detergent composition according to the invention. Together with enzymes also enzyme stabilizing systems may be used such as for example calcium ions, boric acid, boronic acid, propylene glycol and short chain carboxylic acids. In the context of the present invention, short chain carboxylic acids are selected from monocarboxylic acids with 1 to 3 carbon atoms per molecule and from dicarboxylic acids with 2 to 6 carbon atoms per molecule. Preferred examples are formic acid, acetic acid, propionic acid, oxalic acid, succinic acid, HOOC(CH₂)₃COOH, adipic acid and mixtures from at least two of the foregoing, as well as the respective sodium and potassium salts.

In one embodiment of the present invention, the cleaning compositions, and preferably the laundry formulations, comprise at least one enzyme; and the inventive polymers are used in combination with at least one enzyme to obtain even further or additionally obtain improvement of oily/fatty stain removal, and/or food stain removal and/or removal of complex stains.

In another embodiment of the present invention, the inventive cleaning compositions do not comprise enzymes.

Compositions according to the invention may comprise one or more bleaching agent (bleaches).

Preferred bleaches are selected from sodium perborate, anhydrous or, for example, as the monohydrate or as the tetrahydrate or so-called dihydrate, sodium percarbonate, anhydrous or, for example, as the monohydrate, and sodium persulfate, where the term “persulfate” in each case includes the salt of the peracid H₂SO₅ and also the peroxodisulfate.

In this connection, the alkali metal salts can in each case also be alkali metal hydrogen carbonate, alkali metal hydrogen perborate and alkali metal hydrogen persulfate. However, the dialkali metal salts are preferred in each case.

Formulations according to the invention can comprise one or more bleach catalysts. Bleach catalysts can be selected from oxaziridinium-based bleach catalysts, bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Formulations according to the invention can comprise one or more bleach activators, for example tetraacetyl ethylene diamine, tetraacetylmethylene diamine, tetraacetylglycoluril, tetraacetylhexylene diamine, acylated phenolsulfonates such as for example n-nonanoyl- or isononanoyloxybenzene sulfonates, N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

Formulations according to the invention can comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol.

In one embodiment of the present invention, formulations according to the invention comprise in total in the range from 0.1 to 1.5% by weight of corrosion inhibitor.

Formulations according to the invention may also comprise further cleaning polymers and/or soil release polymers.

The additional cleaning polymers may include, without limitation, “multifunctional polyethylene imines” (for example BASF's Sokalan® HP20) and/or “multifunctional diamines” (for example BASF's Sokalan® HP96). Such multifunctional polyethylene imines are typically ethoxylated polyethylene imines with a weight-average molecular weight M_{W} in the range from 3000 to 250000, preferably 5000 to 200000, more preferably 8000 to 100000, more preferably 8000 to 50000, more preferably 10000 to 30000, and most preferably 10000 to 20000 g/mol. Suitable multifunctional polyethylene imines have 80 wt % to 99 wt %, preferably 85 wt % to 99 wt %, more preferably 90 wt % to 98 wt %, most preferably 93 wt % to 97 wt % or 94 wt % to 96 wt % ethylene oxide side chains, based on the total weight of the materials. Ethoxylated polyethylene imines are typically based on a polyethylene imine core and a polyethylene oxide shell. Suitable polyethylene imine core molecules are polyethylene imines with a weight-average molecular weight M_{w} in the range of 500 to 5000 g/mol. Preferably employed is a molecular weight from 500 to 2000 g/mol, even more preferred is a M_{W} of 600 to 800 g/mol. The ethoxylated polymer then has on average 5 to 50, preferably 10 to 35 and even more preferably 20 to 35 ethylene oxide (EO) units per NH-functional group.

Suitable multifunctional diamines are typically ethoxylated C2 to C12 alkylene diamines, preferably hexamethylene diamine, which are further quaternized and optionally sulfated. Typical multifunctional diamines have a weight-average molecular weight M_{W} in the range from 2000 to 10000, more preferably 3000 to 8000, and most preferably 4000 to 6000 g/mol. In a preferred embodiment of the invention, ethoxylated hexamethylene diamine, furthermore quaternized and sulfated, may be employed, which contains on average 10 to 50, preferably 15 to 40 and even more preferably 20 to 30 ethylene oxide (EO) groups per NH-functional group, and which preferably bears two cationic ammonium groups and two anionic sulfate groups.

In a preferred embodiment of the present invention, the cleaning compositions may contain at least one multifunctional polyethylene imine and/or at least one multifunctional diamine to improve the cleaning performance, such as preferably improve the stain removal ability, especially the primary detergency of particulate stains on polyester fabrics of laundry detergents. The multifunctional polyethylene imines or multifunctional diamines or mixtures thereof according to the descriptions above may be added to the laundry detergents and cleaning compositions in amounts of generally from 0.05 to 15 wt %, preferably from 0.1 to 10 wt % and more preferably from 0.25 to 5 wt % and even as low as up to 2 wt. %, based on the particular overall composition, including other components and water and/or solvents.

Thus, one aspect of the present invention is a laundry detergent composition, in particular a liquid laundry detergent, comprising (i) at least one inventive polymer and (ii) at least one compound selected from multifunctional polyethylene imines and multifunctional diamines and mixtures thereof.

In one embodiment of the present invention, the ratio of the at least one inventive polymer and (ii) the at least one compound selected from multifunctional polyethylene imines and multifunctional diamines and mixtures thereof, is from 10:1 to 1:10, preferably from 5:1 to 1:5 and more preferably from 3:1 to 1:3.

Laundry formulations comprising the inventive polymer may also comprise at least one antimicrobial agent.

One or more antimicrobial agents and/or preservatives as listed in patent WO2021/115912 A1 (“Formulations comprising a hydrophobically modified polyethyleneimine and one or more enzymes”) pages 35 to 39 may be employed.

Especially preferred are the following antimicrobial agents and/or preservatives:
4,4′-dichloro 2-hydroxydiphenyl ether (CAS-No. 3380-30-1), further names: 5-chloro-2-(4-chlorophenoxy) phenol, Diclosan, DCPP, which is commercially available as a solution of 30 wt % of 4,4′-dichloro 2-hydroxydiphenyl ether in 1,2 propyleneglycol under the trade name Tinosan® HP 100 (BASF);
2-Phenoxyethanol (CAS-no. 122-99-6, further names: Phenoxyethanol, Methylphenyl-glycol, Phenoxetol, ethylene glycol phenyl ether, Ethylene glycol monophenyl ether, Protectol® PE);
2-bromo-2-nitropropane-1,3-diol (CAS-No. 52-51-7, further names: 2-bromo-2-nitro-1,3-propanediol, Bronopol®, Protectol® BN, Myacide AS);
Glutaraldehyde (CAS-No. 111-30-8, further names: 1-5-pentandial, pentane-1,5-dial, glutaral, glutardialdehyde, Protectol® GA, Protectol® GA 50, Myacide® GA);
Glyoxal (CAS No. 107-22-2; further names: ethandial, oxylaldehyde, 1,2-ethandial, Protectol® GL);
2-butyl-benzo[d]isothiazol-3-one (BBIT, CAS No. 4299-07-4);
2-methyl-2H-isothiazol-3-one (MIT, CAS No 2682-20-4);
2-octyl-2H-isothiazol-3-one (OIT, CAS No. 26530-20-1);
5-Chloro-2-methyl-2H-isothiazol-3-one (CIT, CMIT, CAS No. 26172-55-4);
Mixture of 5-chloro-2-methyl-2H-isothiazol-3-one (CMIT, EINECS 247-500-7) and 2-methyl-2H-isothiazol-3-one (MIT, EINECS 220-239-6) (Mixture of CMIT/MIT, CAS No. 55965-84-9);
1,2-benzisothiazol-3(2H)-one (BIT, CAS No. 2634-33-5);
Hexa-2,4-dienoic acid (Sorbic acid, CAS No. 110-44-1) and its salts, e.g. calcium sorbate, sodium sorbate
Potassium (E,E)-hexa-2,4-dienoate (Potassium Sorbate, CAS No. 24634-61-5);
Lactic acid and its salts;
L-(+)-lactic acid (CAS No. 79-33-4);
Benzoic acid and its sodium salt (CAS No 65-85-0, CAS No. 532-32-1) and salts of benzoic acid e.g. ammonium benzoate, calcium benzoate, magnesium benzoate, MEA-benzoate, potassium benzoate;
Salicylic acid and its salts, e.g. calcium salicylate, magnesium salicylate, MEA salicylate, sodium salicylate, potassium salicylate, TEA salicylate;
Benzalkonium chloride, bromide and saccharinate, e.g. benzalkonium chloride, benzalkonium bromide, benzalkonium saccharinate (CAS Nos 8001-54-5, 63449-41-2, 91080-29-4, 68989-01-5, 68424-85-1, 68391-01-5, 61789-y71-7, 85409-22-9);
Didecyldimethylammonium chloride (DDAC, CAS No. 68424-95-3 and CAS No. 7173-51-5);
N-(3-aminopropyl)-N-dodecylpropane-1,3-diamine (Diamine, CAS No. 2372-82-9); Peracetic acid (CAS No. 79-21-0);
Hydrogen peroxide (CAS No. 7722-84-1);

The further antimicrobial agent or preservative is added to the composition in a concentration of 0.001 to 10% relative to the total weight of the composition.

Preferably, the composition contains 2-Phenoxyethanol in a concentration of 0.1 to 2% or 4,4′-dichloro 2-hydroxydiphenyl ether (DCPP) in a concentration of 0.005 to 0.6%.

The invention thus further pertains to a method of preserving an aqueous composition according to the invention against microbial contamination or growth, which method comprises addition of 2-Phenoxyethanol.

The invention thus further pertains to a method of providing an antimicrobial effect on textiles after treatment with a solid laundry detergent e.g. powders, granulates, capsules, tablets, bars etc.), a liquid laundry detergent, a softener or an after rinse containing 4,4′-dichloro 2-hydroxydiphenyl ether (DCPP).

Formulations according to the invention may also comprise water and/or additional organic solvents, e.g. ethanol or propylene glycol.

Further optional ingredients may be but are not limited to viscosity modifiers, cationic surfactants, foam boosting or foam reducing agents, perfumes, dyes, optical brighteners, and dye transfer inhibiting agents.

### General Cleaning Compositions and Formulations

In a preferred embodiment the polymer according to the present invention is used in a laundry detergent.

Liquid laundry detergents according to the present invention are composed of:

| | |
|---|---|
| 0.05-20% | of at least one inventive polymer |
| 1-50% | of surfactants |
| 0.1-40% | of builders, cobuilders and/or chelating agents |
| 0.1-50% | other adjuncts |

water to add up 100%.

Preferred liquid laundry detergents according to the present invention are composed of:

| | |
|---|---|
| 0.2-6% | of at least one inventive polymer |
| 5-40% | of anionic surfactants selected from C10-C15- LAS and C10-C18 alkyl |
| | ethersulfate containing 1-5 ethylenoxy-units |
| 1.5-10% | of nonioic surfactants selected from C10-C18-alkyl ethoxylates containing |
| | 3-10 ethylenoxy-units |
| 2-20% | of soluble organic builders/cobuilders selected from C10-C18 fatty acids, |
| | di- and tricarboxylic acids, hydroxy-di- and hydroxytricaboxylic acids and |
| | polycarboxylic acids |
| 0.05-5% | of an enzyme system containing at least one enzyme suitable for detergent |
| | use and preferably also an enzyme stabilizing system |
| 0.5-20% | of mono- or diols selected from ethanol, isopropanol, ethylenglycol, or |
| | propylenglyclol |
| 0.1-20% | other adjuncts |

water to add up to 100%

Solid laundry detergents (like e.g. powders, granules or tablets) according to the present invention are composed of:

| | |
|---|---|
| 0.05-20% | of at least one inventive polymer |
| 1-50% | of surfactants |
| 0.1-80% | of builders, cobuilders and/or chelating agents |
| 0-50% | fillers |
| 0-40% | leach actives |
| 0.1-30% | other adjuncts and/or water |

where in the sum of the ingredients adds up 100%.

wherein the sum of the ingredients adds up 100%.

Preferred solid laundry detergents according to the present invention are composed of:

| | |
|---|---|
| 0.2-6% | of at least one inventive polymer |
| 5-30% | of anionic surfactants selected from C10-C15- LAS, C10-C18 alkylsulfates |
| | and C10-C18 alkyl ethersulfate containing 1-5 ethylenoxy-units |
| 1.5-7.5% | of nonionic surfactants selected from C10-C18-alkyl ethoxylates containing |
| | 3-10 ethylenoxy-units |
| 5-50% | of inorganic builders selected from sodium carbonate, sodiumbicarbonate, |
| | zeolites, soluble silicates, sodium sulfate |
| 0.5-15% | of cobuilders selected from C10-C18 fatty acids, di- and tricarboxylic acids, |
| | hydroxydi- and hydroxytricarboxylic acids and polycarboxylic acids |
| 0.1-5% | of an enzyme system containing at least one enzyme suitable for detergent |
| | use and preferably also an enzyme stabilizing system |
| 0.5-20% | of mono- or diols selected from ethanol, isopropanol, ethylenglycol, or |
| | propylenglyclol |
| 0.1-20% | other adjuncts |

water to ad up to 100%

The following table shows general cleaning compositions of certain types, which correspond to typical compositions correlating with typical washing conditions as typically employed in various regions and countries of the world. The at least one inventive polymer may be added to such formulation(s) in suitable amounts as outlined herein.

TABLE 1
General formula for detergent compositions
according to the invention:

| | Ranges of Ingredient in |
|---|---|
| Ingredient | Liquid frame formulations |
| Linear alkyl benzene sulphonic acid | 0 to 30% |
| Coco fatty acid | 1 to 12% |
| Fatty alcohol ether sulphate | 0 to 25% |
| NaOH or mono or triethanol amine | Up to pH 7.5 to 9.0 |
| Alcohol ethoxylate | 3 to 10% |
| 1,2-Propylene glycol | 1 to 10% |
| Ethanol | 0 to 4% |
| Sodium citrate | 0 to 8% |
| water | Up to 100% |

TABLE 2
Liquid frame formulations according to the invention:

| active | | | | | | |
|---|---|---|---|---|---|---|
| (numbers: % active) | F1 | F2 | F3 | F4 | F5 | F6 |
| alcohol ethoxylat 7EO | 5.40 | 10.80 | 12.40 | 7.30 | 1.60 | 7.60 |
| Coco fatty acid K12-18 | 2.40 | 3.10 | 3.20 | 3.20 | 3.50 | 6.40 |
| Fatty alcohol ether | 5.40 | 8.80 | 7.10 | 7.10 | 5.40 | 14.00 |
| sulphate | | | | | | |
| Linear alkyl benzene | 5.50 | 0.00 | 14.50 | 15.50 | 10.70 | 0.00 |
| sulphonic acid | | | | | | |
| 1,2 Propandiol | 6.00 | 3.50 | 8.70 | 8.70 | 1.10 | 7.80 |
| Triethanolamine | | | | | | |
| Monoethanolamine | | | 4.00 | 4.30 | 0.30 | |
| NaOH | 2.20 | 1.10 | | | | 1.00 |
| Glycerol | | 0.80 | 3.00 | 2.80 | | |
| Ethanol | 2.00 | | | | 0.38 | 0.39 |
| Na citrate | 3.00 | 2.80 | 3.40 | 2.10 | 7.40 | 5.40 |
| Inventive Polymer (s) | 0-5 | 0-5 | 0-5 | 0-5 | 0-5 | 0-5 |
| (total) | | | | | | |
| Protease | 0-1 | 0-1 | 0-1 | 0-1 | 0-1 | 0-1 |
| Amylase | 0-0.5 | 0-0.5 | 0-0.5 | 0-0.5 | 0-0.5 | 0-0.5 |
| Cellulase | 0-0.3 | 0-0.3 | 0-0.3 | 0-0.3 | 0-0.3 | 0-0.3 |
| Lipase | 0-0.2 | 0-0.2 | 0-0.2 | 0-0.2 | 0-0.2 | 0-0.2 |
| Mannanase | 0-0.2 | 0-0.2 | 0-0.2 | 0-0.2 | 0-0.2 | 0-0.2 |
| Pectat Lyase | 0-0.3 | 0-0.3 | 0-0.3 | 0-0.3 | 0-0.3 | 0-0.3 |
| water | to 100 | to 100 | to 100 | to 100 | to 100 | to 100 |

| active | | | | | | | | |
|---|---|---|---|---|---|---|---|---|
| (numbers: % active) | F7 | F8 | F9 | F10 | F11 | F12 | F13 | F14 |
| alcohol ethoxylat 7EO | 3.80 | 0.30 | 13.30 | 8.00 | 5.70 | 20.00 | 9.20 | 29.00 |
| Coco fatty acid K12-18 | 2.80 | 3.00 | 1.70 | 1.80 | 2.50 | 5.00 | 8.60 | 10.40 |
| Fatty alcohol ether | 2.80 | 4.50 | 3.90 | 4.10 | | 10.00 | 22.20 | |
| sulphate | | | | | | | | |
| Linear alkyl benzene | 6.30 | 5.43 | 11.45 | 5.90 | 10.10 | 10.00 | 28.00 | 27.00 |
| sulphonic acid | | | | | | | | |
| 1,2 Propandiol | 0.50 | | 2.50 | 0.40 | 6.00 | 10.00 | 7.00 | 7.00 |
| Triethanolamine | | | | 8.10 | | | | |
| Monoethanolamine | 0.40 | 1.80 | | | | | 8.00 | 7.00 |
| NaOH | | | 2.20 | | 3.30 | 1.50 | | |
| Glycerol | | 0.60 | 0.20 | 1.90 | | | 7.00 | 10.00 |
| Ethanol | | | 1.84 | | | | | |
| Na citrate | 4.60 | 3.30 | 3.30 | 1.40 | | 1.50 | | |
| Inventive Polymer (s) | 0-5 | 0-5 | 0-5 | 0-5 | 0-5 | 0-5 | 0-5 | 0-5 |
| (total) | | | | | | | | |
| Protease | 0-1 | 0-1 | 0-1 | 0-1 | 0-1 | 0-3 | 0-3 | 0-3 |
| Amylase | 0-0.5 | 0-0.5 | 0-0.5 | 0-0.5 | 0-0.5 | 0-0.5 | 0-0.5 | 0-0.5 |
| Cellulase | 0-0.3 | 0-0.3 | 0-0.3 | 0-0.3 | 0-0.3 | 0-0.3 | 0-0.3 | 0-0.3 |
| Lipase | 0-0.2 | 0-0.2 | 0-0.2 | 0-0.2 | 0-0.2 | 0-0.2 | 0-0.2 | 0-0.2 |
| Mannanase | 0-0.2 | 0-0.2 | 0-0.2 | 0-0.2 | 0-0.2 | 0-0.2 | 0-0.2 | 0-0.2 |
| Pectat Lyase | 0-0.3 | 0-0.3 | 0-0.3 | 0-0.3 | 0-0.3 | 0-0.3 | 0-0.3 | 0-0.3 |
| water | to 100 | to 100 | to 100 | to 100 | to 100 | to 100 | to 100 | to 100 |

TABLE 3
Powder frame formulations according to the invention:

| | Bleach free Powder | | | | | |
|---|---|---|---|---|---|---|
| Alcohol ethoxylate 7EO | 0.6 | 0 | 1 | 0 | 0 | 5.2 |
| Coco fatty acid K12-18 | 1.2 | 0 | 0 | 0 | 0 | 0 |
| Fatty alcohol ether sulphate | 1.5 | 0 | 0 | 0 | 0 | 6 |
| Linear alkyl benzene | 12.1 | 11.2 | 13.6 | 21.9 | 18.7 | 12.7 |
| sulphonic acid | | | | | | |
| Bleach activator | 0 | 0 | 0 | 0 | 0 | 0 |
| Percarbonate | 0 | 0 | 0 | 0 | 0 | 0 |
| AcetateNa | 0 | 0 | 0 | 0.1 | 0 | 0.1 |
| CitrateNa | 0 | 0 | 0 | 0 | 0 | 14 |
| Na Silicate | 27.9 | 5.8 | 6.6 | 2 | 15 | 20.3 |
| Na Carbonate | 17.2 | 35 | 37.3 | 30.1 | 37 | 1 |
| Na Phospahte | 0 | 0 | 0 | 14 | 0.3 | 0 |
| Na Hydrogencarbonate | 0.7 | 0.9 | 0.5 | 2.7 | 0.4 | 10.5 |
| Zeolite4A | 4.2 | 0.1 | 5.1 | 10.2 | 1.8 | 11.6 |
| HEDP | 0 | 0 | 0 | 0 | 0 | 0.13 |
| MGDA | 0 | 1.1 | 0 | 0 | 0 | 0 |
| Cellulase | 0-0.5 | 0-0.5 | 0-0.5 | 0-0.5 | 0-0.5 | 0-0.5 |
| Lipase | 0-0.4 | 0-0.4 | 0-0.4 | 0-0.4 | 0-0.4 | 0-0.4 |
| Mannanase | 0-0.4 | 0-0.4 | 0-0.4 | 0-0.4 | 0-0.4 | 0-0.4 |
| Protease | 0-1.5 | 0-1.5 | 0-1.5 | 0-1.5 | 0-1.5 | 0-1.5 |
| Amylase | 0-0.5 | 0-0.5 | 0-0.5 | 0-0.5 | 0-0.5 | 0-0.5 |
| Na Sulfate | 30.8 | 1.3 | 33 | 11 | 22 | 3 |
| Na Chloride | 0.2 | 43 | 0.1 | 0 | 0.1 | 0.1 |
| optical brightener | 0.02 | 0 | | 0.1 | 0.06 | |
| Inventive Polymer(s) (total) | 1 | 0 | 0.2 | 2 | 0.5 | 3 |
| | Bleach containing Powder | | | | | |
| Alcohol ethoxylate 7EO | 1.2 | 5 | 4 | 0.5 | 0.5 | 0 |
| Coco fatty acid K12-18 | 0 | 0 | 0 | 0.3 | 0 | 0.6 |
| Fatty alcohol ether sulphate | 0 | 3.9 | 4.4 | 1.6 | 0 | 0 |
| Linear alkyl benzene | 7.6 | 12.1 | 11.5 | 12.2 | 6.5 | 10.4 |
| sulphonic acid | | | | | | |
| Bleach activator | 0.2 | 9.5 | 9.5 | 0.5 | 0.8 | 2.2 |
| Percarbonate | 3.6 | 19.4 | 16.6 | 2.2 | 11.5 | 5.8 |
| AcetateNa | 0 | 6.7 | 7.1 | 0.3 | 1 | 0.7 |
| CitrateNa | 0 | 1.6 | 8.2 | 0.3 | 0.9 | 1.7 |
| Na Silicate | 3.6 | 11.3 | 16.4 | 10.2 | 9.1 | 16.5 |
| Na Carbonate | 21.6 | 8.7 | 1.4 | 8 | 22.9 | 14.8 |
| Na Phospahte | 0 | 0 | 0 | 0 | 0 | 0 |
| Na Hydrogencarbonate | 0.2 | 2.8 | 1.6 | 0.8 | 0.5 | 0.5 |
| Zeolite4A | 1.6 | 1.4 | 2.4 | 1.6 | 1.8 | 2.3 |
| HEDP | 0 | 0.27 | 0.16 | 0 | 0 | 0.17 |
| MGDA | 0 | 0 | 0 | 0 | 0 | 0 |
| Cellulase | 0-0.5 | 0-0.5 | 0-0.5 | 0-0.5 | 0-0.5 | 0-0.5 |
| Lipase | 0-0.4 | 0-0.4 | 0-0.4 | 0-0.4 | 0-0.4 | 0-0.4 |
| Mannanase | 0-0.4 | 0-0.4 | 0-0.4 | 0-0.4 | 0-0.4 | 0-0.4 |
| Protease | 0-1.5 | 0-1.5 | 0-1.5 | 0-1.5 | 0-1.5 | 0-1.5 |
| Amylase | 0-0.5 | 0-0.5 | 0-0.5 | 0-0.5 | 0-0.5 | 0-0.5 |
| Na Sulfate | 51 | 4 | 6 | 57 | 38 | 37 |
| Na Chloride | 1 | 1 | 0.5 | 1.2 | 0.2 | 1 |
| optical brightener | | 0.29 | 0.1 | 0.23 | 0.13 | 0.19 |
| Inventive Polymer(s) (total) | 2.2 | 9.2 | 2.2 | 0.7 | | 0.4 |

The following examples shall further illustrate the present invention without restricting the scope of the invention.

The amount and type of amines substituted with residues such as, for example, those according to formula (IIa) and/or optionally the presence of hydrogen can be determined by identification of primary, secondary and tertiary amino groups in ¹³C-NMR, as described for polyethylene imines in Lukovkin G. M., Pshezhetsky V. S., Murtazaeva G. A.: Europ. Polymer Journal 1973, 9, 559-565 and St. Pierre T., Geckle M.: ACS Polym. Prep. 1981, 22, 128-129.

¹³C-NMR spectra are recorded in CDCl₃ with a Bruker AV-401 instrument at room temperature. ¹H-NMR spectra are recorded in CDCl₃ or CD₃OD with a Bruker AV-401 instrument at room temperature.

Saponification values are measured according to DIN EN ISO 3657: 2013.

### SYNTHESIS EXAMPLES

In the examples, step b) is begun after step a) is ended and step c) is begun after step b) is ended.

### Example 1: PE1800+0.92 EO Per Mol of NH Functionality+1 Caprolactone Per Mol of NH Functionality+20 EO Per Mol of NH Functionality

### Example 1a: PE1800+0.92 EO Per Mol of NH Functionality

A 2 l autoclave is charged with 779.0 g of a polyethylenimine with an average molecular weight of 800 g/mol and 127.9 g water. The reactor is purged three times with nitrogen and heated to 135° C. 734.2 g ethylene oxide is added within 20 hours. To complete the reaction, the reaction mixture is allowed to post-react for 5 hours at 135° C. Volatile compounds are removed in vacuo at 100° C. A highly viscous yellow oil (1600.0 g, pH: 11.05 (5% in water)) is obtained.

### Example 1b: PE1800+0.92 EO Per Mol of NH Functionality+1 Caprolactone Per Mol of NH Functionality

In a 3-neck reaction vessel with stirrer, thermometer, and reflux cooler 150.3 g polyethylene imine, molecular weight 800 g/mol+0.92 EO per mol of NH functionality (example 1a) are placed. 207.5 g caprolactone are added in one portion. At 44° C. 0.39 g tin (II) 2-ethyl-hexanoate are added. The reaction mixture is heated to 160° C. and is stirred for 32 hours at 160° C. 184.0 g of a brown oil is obtained. 1H-NMR in MeOD indicates complete conversion of caprolactone.

### Example 1c: PE1800+0.92 EO Per Mol of NH Functionality+1 Caprolactone Per Mol of NH Functionality+20 EO Per Mol of NH Functionality

In a 2 l autoclave 160.0 g polyethylene imine, molecular weight 800 g/mole, +0.92 EO per mol of NH functionality+1.0 caprolactone per mol of NH functionality (example 1b) and 1.7 g potassium tert. butoxide are placed and the mixture is heated to 120° C. The vessel is purged three times with nitrogen. 677.4 g ethylene oxide is added in portions within 10 h. To complete the reaction, the mixture is allowed to post-react for additional 5 h at 120° C. The reaction mixture is stripped with nitrogen and volatile compounds are removed in vacuo at 80° C. 838.0 g of a viscous brown oil is obtained (saponification value: 2.7 mgKOH/g).

### Example 2: N4 Amine+0.9 EO Per Mol of NH Functionality+0.9 Caprolactone Per Mol of NH Functionality+20 EO Per Mol of NH Functionality

### Example 2a: N4 Amine+0.9 EO/NH

200 g of N4 amine and 20 g water are charged to a steel pressure reactor. The reactor is purged with nitrogen to remove air and a nitrogen pressure of 2 bar is set. The reactor is heated to 100° C. and 273 g of ethylene oxide are dosed into the reactor within seven hours. After that, the reaction mixture is kept at 100° C. for post reaction. Volatile compounds are removed under vacuum and 470 g of a yellow and highly viscous product is removed from the reactor.

### Example 2b: N4 Amine+0.9 EO/NH+0.9 CL/NH

160 g of the previously obtained product are charged into a four-necked round bottom flask equipped with a cooler and a dripping funnel under nitrogen atmosphere and heated to 80° C. 269 g of caprolactone are added slowly at 80° C. After caprolactone addition, the temperature is increased slowly to 160° C. and the mixture is allowed to post-react over-night at 160° C. 427 g of a dark, highly viscous liquid were obtained.

### Example 2c: N4 Amine+0.9 EO/NH+0.9 CL/NH+20 EO/NH

130 g of the previously obtained product are filled into a steel pressure reactor and 4.66 g of potassium methanolate (32.5 wt % in methanol) are added. Methanol is removed at 20 mbars at 80° C. The reactor is purged with nitrogen to remove air and a nitrogen pressure of 1.5 bars is set. The reactor is heated to 120° C. and 627 g of ethylene oxide are dosed into the reactor within ten hours. The mixture is allowed to post react for seven hours at 120° C. 763 g of a brown solid were obtained as product.

### Example 2*: PO Analogon to Example 2

N4 amine+0.9 PO per mol of NH functionality+0.9 Caprolactone per mol of NH functionality+20 EO per mol of NH functionality

### Example 2*a: N4 Amine+0.9 PO Per Mol of NH Functionality

A 3.5 l autoclave is charged with 200.0 g N4 amine and 20.0 g water. The reactor is purged three times with nitrogen and heated to 100° C. 360.0 g propylene oxide is added within 3 hours. To complete the reaction, the reaction mixture is allowed to post-react for 7 hours at 100° C. Volatile compounds are removed in vacuo at 90° C. A highly viscous colorless oil (566.7 g) is obtained (amine value 402 mg KOH/g).

### Example 2*b: N4 Amine+0.9 PO Per Mol of NH Functionality+0.9 Caprolactone Per Mol of NH Functionality

In a 3-neck reaction vessel with stirrer, thermometer, and reflux cooler 110.0 g N4 amine+0.9 PO per mol of NH functionality (example 2*a) are placed at 70° C. 135.0 g caprolactone are added in one portion at 70° C. The reaction mixture is heated to 160° C. and is stirred overnight at 160° C. 240.0 g of a black, viscous liquid is obtained. 1H-NMR in MeOD indicates complete conversion of caprolactone.

### Example 2*c: N4 Amine+0.9 PO Per Mol of NH Functionality+0.9 Caprolactone Per Mol of NH Functionality+20 EO Per Mol of NH Functionality

In a 2 l autoclave 110.0 g N4 amine+0.9 PO per mol of NH functionality+1.0 caprolactone per mol of NH functionality (example 2a-b) and 1.7 g potassium methoxide are placed and the mixture is heated to 120° C. The vessel is purged three times with nitrogen. 719.0 g ethylene oxide is added in portions within 15 h. To complete the reaction, the mixture is allowed to post-react for additional 7 h at 120° C. The reaction mixture is stripped with nitrogen and volatile compounds are removed in vacuo at 90° C. 526.3 g of a light brown solid is obtained (amine value 54 mgKOH/g).

### Example 3: PEI800+0.9 PO Per Mol of NH Functionality+0.9 Caprolactone Per Mol of NH Functionality+20 EO Per Mol of NH Functionality

### Example 3a: PEI 800+0.9 PO/NH

302 g of PEI 800 and 30.2 g water are charged to a steel pressure reactor. The reactor is purged with nitrogen to remove air and a nitrogen pressure of 2 bar is set. The reactor is heated to 100° C. and 368 g of propylene oxide are dosed into the reactor within 14 hours. After that, the reaction mixture is kept at 100° C. for post reaction. Volatile compounds are removed under vacuum and 668 g of a yellow and highly viscous product is removed from the reactor.

### Example 3b: (PEI 800+0.9 PO/NH)+0.9 CL/NH

90 g of the previously obtained product are charged into a four-necked round bottom flask equipped with a cooler and a dripping funnel under nitrogen atmosphere. The reaction mixture is heated to 80° C. and 97 g of caprolactone are added slowly at 80° C. After caprolactone addition, the temperature is increased slowly to 120° C. and the mixture is allowed to post-react for 24 hours at 120° C. 182 g of a brownish, highly viscous liquid were obtained.

### Example 3c: (PEI 800+0.9 PO/NH+0.9 CL/NH)+20 EO/NH

153 g of the previously obtained product are filled into a steel pressure reactor and 5.0 g of potassium methanolate (32.5 wt % in methanol) are added. Methanol is removed at 20 mbars at 80° C. The reactor is purged with nitrogen to remove air and a nitrogen pressure of 1.5 bars is set. The reactor is heated to 120° C. and 682 g of ethylene oxide are dosed into the reactor within 12 hours. The mixture is allowed to post react for seven hours at 120° C. 790 g of a light brown solid were obtained as product.

### Example 4: PEI800+0.9 PO Per Mol of NH Functionality+1.8 Caprolactone Per Mol of NH Functionality+20 EO Per Mol of NH Functionality

### Example 4a: PEI 800+0.9 PO/NH

302 g of PEI 800 and 30.2 g water are charged to a steel pressure reactor. The reactor is purged with nitrogen to remove air and a nitrogen pressure of 2 bar is set. The reactor is heated to 100° C. and 368 g of propylene oxide are dosed into the reactor within 14 hours. After that, the reaction mixture is kept at 100° C. for post reaction. Volatile compounds are removed under vacuum and 668 g of a yellow and highly viscous product is removed from the reactor.

### Example 4b: (PEI 800+0.9 PO/NH)+1.8 CL/NH

70 g of the previously obtained product are charged into a four-necked round bottom flask equipped with a cooler and a dripping funnel under nitrogen atmosphere. 2.9 g of tin-II (ethylhexanoate)₂ (1 mol %) are charged to the reactor. The reaction mixture is heated to 80° C. and 169 g of caprolactone are added slowly at 80° C. After caprolactone addition, the temperature is increased slowly to 120° C. and the mixture is allowed to post-react four hours at 120° C. 236 g of an orange, highly viscous liquid were obtained.

### Example 4c: (PEI 800+0.9 PO/NH+1.8 CL/NH)+20 EO/NH

105 g of the previously obtained product are filled into a steel pressure reactor and 2.5 g of potassium methanolate (32.5 wt % in methanol) are added. Methanol is removed at 20 mbars at 80° C. The reactor is purged with nitrogen to remove air and a nitrogen pressure of 1.5 bars is set. The reactor is heated to 120° C. and 308 g of ethylene oxide are dosed into the reactor within six hours. The mixture is allowed to post react for 12 hours at 120° C. 406 g of a light brown solid were obtained as product.

### Example 5: PE1800+0.5 EO Per Mol of NH Functionality+0.5 Caprolactone Per Mol of NH Functionality+20 EO Per Mol of NH Functionality

### example 5a: PEI 800+0.5 EO/NH

500 g of PEI 800 and 50 g water are charged to a steel pressure reactor. The reactor is purged with nitrogen to remove air and a nitrogen pressure of 2 bar is set. The reactor is heated to 100° C. and 257 g of ethylene oxide are dosed into the reactor within ten hours. After that, the reaction mixture is kept at 100° C. for post reaction. Volatile compounds are removed under vacuum and 753 g of a yellow and highly viscous product is removed from the reactor.

### Example 5b: (PEI 800+0.5 EO/NH)+0.5 CL/NH

250 g of the previously obtained product are charged into a four-necked round bottom flask equipped with a cooler and a dripping funnel under nitrogen atmosphere and heated to 80° C. 222 g of caprolactone are added slowly at 80° C. After caprolactone addition, the temperature is slowly increased to 160° C. and the mixture is allowed to post-react over-night at 160° C. 465 g of a brown, highly viscous liquid were obtained.

### Example 5c: (PEI 800+0.5 EO/NH+0.5 CL/NH)+19.5 EO/NH

103 g of the previously obtained product are filled into a steel pressure reactor and 5.0 g of potassium methanolate (32.5 wt % in methanol) are added. Methanol is removed at 20 mbars at 80° C. The reactor is purged with nitrogen to remove air and a nitrogen pressure of 2 bars is set. The reactor is heated to 120° C. and 722 g of ethylene oxide are dosed into the reactor within eleven hours. The mixture is allowed to post react for seven hours at 120° C. 825 g of a light brown solid were obtained as product.

### Example 6: PE1800+0.5 EO Per Mol of NH Functionality+1.0 Caprolactone Per Mol of NH Functionality+20 EO Per Mol of NH Functionality

### Example 6a: PEI 800+0.5 EO/NH

500 g of PEI 800 and 50 g water are charged to a steel pressure reactor. The reactor is purged with nitrogen to remove air and a nitrogen pressure of 2 bar is set. The reactor is heated to 100° C. and 257 g of ethylene oxide are dosed into the reactor within ten hours. After that, the reaction mixture is kept at 100° C. for post reaction. Volatile compounds are removed under vacuum and 753 g of a yellow and highly viscous product is removed from the reactor.

### Example 6b: (PEI 800+0.5 EO/NH)+1.0 CL/NH

250 g of the previously obtained product are charged into a four-necked round bottom flask equipped with a cooler and a dripping funnel under nitrogen atmosphere and heated to 80° C. 443 g of caprolactone are added slowly at 80° C. After caprolactone addition, the temperature is slowly increased to 160° C. and the mixture is allowed to post-react over-night at 160° C. 678 g of a brown, highly viscous liquid were obtained.

### Example 6c: (PEI 800+0.5 EO/NH+1.0 CL/NH)+19.5 EO/NH

130 g of the previously obtained product are filled into a steel pressure reactor and 4.7 g of potassium methanolate (32.5 wt % in methanol) are added. Methanol is removed at 20 mbars at 80° C. The reactor is purged with nitrogen to remove air and a nitrogen pressure of 2 bars is set. The reactor is heated to 120° C. and 630 g of ethylene oxide are dosed into the reactor within eleven hours. The mixture is allowed to post react for six hours at 120° C. 762 g of a light brown solid were obtained as product.

### Example 7: PEI800+0.92 EO Per Mol of NH Functionality+1.0 Caprolactone Per Mol of NH Functionality+10 PO Per Mol of NH Functionality. RA0369-0155

In a 2 l autoclave 160.0 g polyethylene imine, molecular weight 800 g/mole, +0.92 EO per mol of NH functionality+1.0 caprolactone per mol of NH functionality (example 1b) and 1.3 g potassium tert. butoxide are placed and the mixture is heated to 120° C. The vessel is purged three times with nitrogen. 469.9 g propylene oxide is added in portions within 10 h. To complete the reaction, the mixture is allowed to post-react for additional 10 h at 120° C. The reaction mixture is stripped with nitrogen and volatile compounds are removed in vacuo at 80° C. 630.0 g of a viscous brown oil is obtained.

### Example 8: PEI2000+0.9 PO Per Mol of NH Functionality+1.0 Caprolactone Per Mol of NH Functionality+20 EO Per Mol of NH Functionality

### Example 8a: PEI2000+0.9 PO Per Mol of NH Functionality

A 3.5 l autoclave is charged with 680.0 g of a polyethylenimine with an average molecular weight of 2000 g/mol and 102.0 g water. The reactor is purged three times with nitrogen and heated to 100° C. 827 g propylene oxide is added within 10 hours. To complete the reaction, the reaction mixture is allowed to post-react for 6 hours at 100° C. Volatile compounds are removed in vacuo at 90° C. A highly viscous yellow oil (1504.3 g) is obtained.

### Example 8b: PEI2000+0.9 PO Per Mol of NH Functionality+1.0 Caprolactone Per Mol of NH Functionality

In a 3-neck reaction vessel with stirrer, thermometer, and reflux cooler 150.0 g polyethylene imine, molecular weight 2000 g/mol+0.9 PO per mol of NH functionality (example 8a) are placed. 168.0 g caprolactone are added in one portion at 80° C. The reaction mixture is heated to 160° C. and is stirred for 14 hours at 160° C. 310.0 g of a brown oil is obtained. 1H-NMR in MeOD indicates complete conversion of caprolactone.

### Example 8c: PEI2000+0.9 PO Per Mol of NH Functionality+1.0 Caprolactone Per Mol of NH Functionality+20 EO Per Mol of NH Functionality

In a 2 l autoclave 100.0 g polyethylene imine, molecular weight 2000 g/mole, +0.9 PO per mol of NH functionality+1.0 caprolactone per mol of NH functionality (example 8b) and 1.09 g potassium methoxide are placed and the mixture is heated to 120° C. The vessel is purged three times with nitrogen. 445.0 g ethylene oxide is added in portions within 12 h. To complete the reaction, the mixture is allowed to post-react for additional 7 h at 120° C. The reaction mixture is stripped with nitrogen and volatile compounds are removed in vacuo at 90° C. 540.0 g of a light brown solid is obtained (amine value 39 mgKOH/g).

### Example 9: HMDA+0.9 PO Per Mol of NH Functionality+1.0 Caprolactone Per Mol of NH Functionality+20 EO Per Mol of NH Functionality

### Example 9a: HMDA+0.9 PO Per Mol of NH Functionality

A 3.5 l autoclave is charged with 500.0 g hexamethylene diamine and 50.0 g water. The reactor is purged three times with nitrogen and heated to 100° C. 900.0 g propylene oxide is added within 11 hours. To complete the reaction, the reaction mixture is allowed to post-react for 6 hours at 100° C. Volatile compounds are removed in vacuo at 90° C. A highly viscous yellow oil (1436.7 g) is obtained (amine value 341.0 mg KOH/g).

### Example 9b: HMDA+0.9 PO Per Mol of NH Functionality+1.0 Caprolactone Per Mol of NH Functionality

In a 3-neck reaction vessel with stirrer, thermometer, and reflux cooler 150.0 g hexamethylene diamine+0.9 PO per mol of NH functionality (example 9a) are placed. 198.0 g caprolactone are added in one portion at 80° C. The reaction mixture is heated to 160° C. and is stirred for 14 hours at 160° C. 330.0 g of a brown solid is obtained. 1H-NMR in MeOD indicates complete conversion of caprolactone.

### Example 9c: HMDA+0.9 PO Per Mol of NH Functionality+1.0 Caprolactone Per Mol of NH Functionality+20 EO Per Mol of NH Functionality

In a 2 l autoclave 101.8 g hexamethylene diamine+0.9 PO per mol of NH functionality+1.0 caprolactone per mol of NH functionality (example 9b) and 1.2 g potassium methoxide are placed and the mixture is heated to 120° C. The vessel is purged three times with nitrogen. 488.0 g ethylene oxide is added in portions within 12 h. To complete the reaction, the mixture is allowed to post-react for additional 6 h at 120° C. The reaction mixture is stripped with nitrogen and volatile compounds are removed in vacuo at 90° C. 585.6 g of a light brown solid is obtained (amine value 23 mgKOH/g). example 10 (PPI): PPI (40% PDA, 30% N-4-Amin, 30% BAPMA, Copolymer)+0.8 EO/NH+1 CL/NH+20 EO/NH

### Example 10a: PPI (40% PDA, 30% N-4-Amin, 30% BAPMA, Copolymer)+0.8 EO/NH

400 g of the PPI (polypropylene imine obtained from N-4-amine-BAPMA-1,3-PDA copolymer) and 40 g water are charged to a steel pressure reactor. The reactor is purged with nitrogen to remove air and a nitrogen pressure of 1 bar is set. The reactor is heated to 100° C. and 265 g of ethylene oxide are dosed into the reactor within five hours. After that, the reaction mixture is kept at 100° C. for post reaction. Volatile compounds are removed under vacuum and 664 g of a yellow and highly viscous product is removed from the reactor.

### Example 10b: PPI (40% PDA, 30% N-4-Amin, 30% BAPMA, Copolymer)+0.8 EO/NH+1 CL/NH

127 g of the previously obtained product are charged into a four-necked round bottom flask equipped with a cooler and a dripping funnel under nitrogen atmosphere. 5.6 g of tin-II (ethylhexanoate)₂ (1 mol %) are charged to the reactor. The reaction mixture is heated to 80° C. and 158 g of caprolactone are added slowly at 80° C. After caprolactone addition, the temperature is increased slowly to 160° C. and the mixture is allowed to post-react four hours at 160° C. 271 g of a highly viscous liquid were obtained.

### Example 10c: PPI (40% PDA, 30% N-4-Amin, 30% BAPMA, Copolymer)+0.8 EO/NH+1 CL/NH+20 EO/NH

150 g of the previously obtained ethoxylate are filled into a steel pressure reactor and 1.64 g of potassium tert-butoxide are added. The reactor is purged with nitrogen to remove air and a nitrogen pressure of 2.5 bars is set. The reactor is heated to 120° C. and 669 g of ethylene oxide are dosed into the reactor within ten hours. The mixture is allowed to post react for 12 hours at 120° C. 821 g of a light brown solid were obtained as product.

### Example 11: PE1800+1.1 BO/NH+2.3 CL/OH+23 EO/OH

### Example 11a: PEI 800+1.1 BO/NH

250 g of PEI 800 and 25 g water are charged to a steel pressure reactor. The reactor is purged with nitrogen to remove air and a nitrogen pressure of 1.5 bar is set. The reactor is heated to 100° C. and 461 g of butylene oxide are dosed into the reactor within 14 hours. After that, the reaction mixture is kept at 100° C. for post reaction. Volatile compounds are removed under vacuum and 702 g of a light yellow and highly viscous product is removed from the reactor.

### Example 11b: (PEI 800+1.1 BO/NH)+2.3 CL/OH

250 g of the previously obtained product are charged into a four-necked round bottom flask equipped with a cooler and a dripping funnel under nitrogen atmosphere. The product is heated to 80° C. and 527 g of caprolactone are added slowly at 80° C. After caprolactone addition, the temperature is increased slowly to 160° C. and the mixture is allowed to post-react sixteen hours at 160° C. 749 g of a light brown, highly viscous liquid were obtained.

### Example 11c: (PEI 800+1.1 BO/NH+2.3 CL/OH)+23 EO/OH

140 g of the previously obtained product are filled into a steel pressure reactor and 3.2 g of potassium methanolate (32.5 wt % in methanol) are added. Methanol is removed at 20 mbar at 80° C. The reactor is purged with nitrogen to remove air and a nitrogen pressure of 2 bar is set. The reactor is heated to 120° C. and 374 g of ethylene oxide are dosed into the reactor within six hours. The mixture is allowed to post react for 6 hours at 120° C. After evaporation of residual ethylene oxide, 507 g of a dark orange highly viscous liquid were obtained as product.

### Comparative Example 1

PE1800+20 EO/NH, Synthesized as Described in WO9532272

### Comparative Example

Polyethylene Imine, Molecular Weight 800 g/Mole, Ethoxylated with 20 Mole Ethylene Oxide Per Mole of NH-Functionality

### Comparative Example 1a

Polyethylene Imine, Molecular Weight 800 g/Mole, Ethoxylated with 1 Mole Ethylene Oxide Per Mole of NH-Functionality

A 5 l autoclave is charged with 1943.0 g of a polyethylenimine with an average molecular weight of 800 g/mol and 97.0 g water. The reactor is purged three times with nitrogen and heated to 110° C. 1789.0 g ethylene oxide is added within 14 hours. To complete the reaction, the reaction mixture is allowed to post-react for 5 hours. Water and volatile compounds are removed in vacuo at 90° C. A highly viscous yellow oil (3688.0 g, water content: 2.6%, pH: 11.05 (5% in water)) is obtained.

### Comparative Example 1b

Polyethylene Imine, Molecular Weight 800 g/Mole, Ethoxylated with 20 Mole Ethylene Oxide Per Mole of NH-Functionality

Product similar to comparative example 1 a (144.6 g, 92.7% in water) and 4.34 g potassium hydroxide (50% in water) are placed in a 2 l autoclave. The mixture is heated under vacuum (<10 mbar) to 120° C. and stirred for 2 hours to remove water. The reactor is purged three times with nitrogen and the mixture is heated to 140° C. 1470.7 g ethylene oxide is added within 14 hours. To complete the reaction, the mixture is allowed to post-react for 5 hours. Volatile compounds are removed in vacuo. 1615.0 g of a slightly brown solid were obtained (melting point: 35.4° C.).

Biodegradation Data:

Biodegradation in wastewater was tested in triplicate using the OECD 301F manometric respirometry method. OECD 301 F is an aerobic test that measures biodegradation of a sample by measuring the consumption of oxygen. To a measured volume of medium, 100 mg/L test substance, which is the nominal sole source of carbon is added along with the inoculum (30 mg/L, aerated sludge taken from Mannheim waste water treatment plant). This is stirred in a closed flask at a constant temperature (20° C.) for 28 days. The consumption of oxygen is determined by measuring the change in pressure in the apparatus using an OxiTop® C (Xylem 35 Analytics Germany Sales GmbH & Co KG). Evolved carbon dioxide is absorbed in a solution of sodium hydroxide. Nitrification inhibitors are added to the flask to prevent usage of oxygen due to nitrification. The amount of oxygen taken up by the microbial population during biodegradation of the test substance (corrected for uptake by blank inoculum, run in parallel) is expressed as a percentage of ThOD (Theoritical oxygen demand, which is measured by the elemental analysis of the compound). A positive control Glucose/Glucosamine is run along with the test samples for each cabinet.

TABLE 4
Biodegradation

| patent | amine/ | | | | biodegradation % | biodegradation % |
|---|---|---|---|---|---|---|
| example # | imine | step a) | step b) | step c) | (28 d) | (56 d) |
| #1 | PEI800 | 0.9 EO/NH | 1 CL/OH | 20 EO | 74 | |
| #2 | N4 amine | 0.9 EO/NH | 1 CL/OH | 20 EO | 69 | 76 |
| #2* | N4 amine | 0.9 PO/NH | 0.9 CL/OH | 20 EO | 55 | 62 |
| #4 | PEI800 | 0.9 PO/NH | 1.8 CL/OH | 20 EO | 53 | 62 |
| #5 | PEI800 | 0.5 EO/NH | 0.5 CL/OH | 19.5 EO | 49 | 59 |
| #6 | PEI800 | 0.5 EO/NH | 1 CL/OH | 19.5 EO | 64 | 67 |
| #7 | PEI800 | 0.9 EO/NH | 1 CL/OH | 10 PO | 74 | |
| #8 | PEI2000 | 0.9 PO/NH | 0.9 CL/OH | 20 EO | 53 | |
| #9 | HMDA | 0.9 PO/NH | 0.9 CL/OH | 20 EO | 26 | |
| #11 | PEI800 | 1.1BO/NH | 2.3 CL/OH | 23 EO | 64 | |
| comparative | PEI800 | | | 20 EO | 1 | 10 |
| example 1 | | | | | | |

Each inventive example shows a by far better biodegradability compared to the prior art.

Wash Performance Data:

The following liquid model composition (MC1) was prepared:

Regular liquid detergent model formulation

| | |
|---|---|
| Linear alkyl benzene sulfonic acid, sodium salt | 5.5 |
| Alcohol ethoxylated (C13-C15 alcohol with 7 moles of EO) | 5.5 |
| Fatty alcohol ether sulfate (C12-C14, sodium salt) | 5.5 |
| 1,2 propylene glycol | 6 |
| Citrate | 2 |
| Soap | 2.2 |
| Ethanol | 2 |
| Water | to 100 |

1) Full Scale Primary Detergency

The soiled swatches are washed together with cotton ballast fabric (3.5 kg) and 2 soil ballast sheet wfk SBL 2004 (commercially available from wfk Testgewebe GmbH Brueggen) in a Miele Household washing machine Softronic W1935 WTL with cotton short program 30° C. Washing conditions were 45 g test detergent (MC1) as described above, water hardness 2.5 mmol/L, 30° C., 4-fold determination. After the wash the fabrics are dried in the air. The fabrics were instrumentally assessed before and after wash using the MACH5 multi area color measurement instrument from ColourConsult which gives Lab readings. From these Lab readings, AE values were calculated between unwashed and washed stain. The higher the AE value, the better is the performance. To better judge on the pure cleaning effect of the respective polymer sample itself, the obtained values were further expressed in AAE values vs reference without polymer (baseline correction for plain wash effect of detergent only). Again, the higher the values of AAE are observed the better is the performance, respectively.

Table 5. Results of full scale primary detergency (Miele Softronic W1935 WTL) in regular liquid model formulation on commercially available stains (038KC Cocoa, 023KC Blueberry, PCH-144 Red Pottery Clay, PCH-115 Stanley Clay, PH-145 Tennis Court Clay, PCH-108 Clay Ground Soil) all commercially by CFt or Warwick.

As shown below, the inventive examples show a comparable washing performance compared to the prior art example 1a (set as benchmark=100%). In some cases, the washing performance of the inventive example is even better than that of the benchmark. However, the biodegradability of each inventive example is by far better than that of the benchmark (as shown in table 4).

TABLE 5
Results of Full Scale primary detergency in model formulation MC1 on commercially available stains as indicated below.

| | | | | | Primary | | | | DDE | | DDE | DDE |
|---|---|---|---|---|---|---|---|---|---|---|---|---|
| | | | | | detergency | DDE | | DDE | stain #3 | DDE | stain #5 | stain #6 |
| inventive | | | | | in % vs | sum | DDE | stain #2 | Red | stain #4 | Tennis | Clay |
| example #/ | | | | | perfor- | over | stain #1 | blue- | Pottery | Stanley | Court | Ground |
| comparative | amine/ | | | | mance | all | cocoa | berry | Clay | Clay | Clay | Soil |
| example | imine | step a) | step b) | step c) | of 1a | stains | (038KC) | (023KC) | (PCH144) | (PCH115) | (PH145) | (PCH108) |
| #5 | PEI800 | 0.5 | 0.5 | 19.5 | 87 | 12.3 | 2.6 | 2.6 | 2.6 | 2.0 | 1.1 | 1.4 |
| | | EO/NH | CL/OH | EO | | | | | | | | |
| #6 | PEI800 | 0.5 | 1 | 19.5 | 78 | 11 | 4.5 | 0.1 | 1.4 | 1.2 | 2.7 | 1.1 |
| | | EO/NH | CL/OH | EO | | | | | | | | |
| #1 | PEI800 | 0.9 | 0.9 | 20 | 53 | 7.5 | 2.8 | 0.6 | 1.3 | 1.0 | 1.1 | 0.7 |
| | | EO/NH | CL/OH | EO | | | | | | | | |
| #2 | N4 amine | 0.9 | 1 | 20 | 65 | 9.1 | 4.0 | 0.3 | 0.7 | 1.1 | 2.2 | 0.8 |
| | | EO/NH | CL/OH | EO | | | | | | | | |
| #3 | PEI800 | 0.9 | 0.9 | 20 | 109 | 15.4 | 3.4 | 1.3 | 3.2 | 2.4 | 3.0 | 2.1 |
| | | PO/NH | CL/OH | EO | | | | | | | | |
| #2* | N4 amine | 0.9 | 0.9 | 20 | 74 | 10.5 | 2.3 | 1.6 | 2.2 | 1.9 | 1.9 | 0.6 |
| | | PO/NH | CL/OH | EO | | | | | | | | |
| #4 | PEI800 | 0.9 | 1.8 | 20 | 110 | 15.5 | 3.6 | 1.4 | 2.9 | 2.5 | 3.1 | 2.0 |
| | | PO/NH | CL/OH | EO | | | | | | | | |
| #7 | PEI800 | 0.9 | 1 | 10 | 55 | 7.7 | 2.1 | 0.2 | 1.4 | 1.3 | 1.4 | 1.3 |
| | | EO/NH | CL/OH | PO | | | | | | | | |
| #8 | PEI2000 | 0.9 | 1 | 20 | 74 | 10.5 | 4.3 | 0.6 | 1.4 | 1.2 | 2.2 | 0.8 |
| | | PO/NH | CL/OH | EO | | | | | | | | |
| #9 | HMDA | 0.9 | 1 | 20 | 65 | 9.2 | 1.8 | 0.8 | 1.7 | 1.2 | 2.9 | 0.8 |
| | | PO/NH | CL/OH | EO | | | | | | | | |
| #10 | PPI | 0.9 | 1 | 20 | 59 | 8.3 | 1.9 | 1.3 | 2.0 | 0.8 | 1.9 | 0.4 |
| | | PO/NH | CL/OH | EO | | | | | | | | |
| #11 | PEI800 | 1.1BO/NH | 2.3 | 23EO | 70 | 9.9 | 0.3 | 0.2 | 2.8 | 2.3 | 2.2 | 2.1 |
| | | | CL/OH | | | | | | | | | |
| comparative | PEI800 | | | 20 | 100 | 14.1 | 2.7 | 2.5 | 2.9 | 2.1 | 2.5 | 1.4 |
| example 1 | | | | EO | | | | | | | | |

2) Primary Detergency in Linitest

The samples were furthermore tested in two further liquid model formulations MC2 (SUD model formulation) and MC3 (LAS free “green” model formulation) with the following composition as below: MC2 (SUD Model Formulation):

| | |
|---|---|
| Linear alkyl benzene sulfonic acid, sodium salt | 26.7 |
| Alcohol ethoxylated (C13-C15 alcohol with 7 moles of EO) | 28.9 |
| 1,2 propylene glycol | 7.0 |
| Monoethanolyamine | 7.0 |
| Soap | 10.4 |
| Glycerol | 9.9 |
| Water | to 100 |

MC3 (LAS Free “Green” Model Formulation):

| | |
|---|---|
| Alcohol ethoxylated (C13-C15 alcohol with 7 moles of EO) | 7.6 |
| Fatty alcohol ether sulfate (C12-C14, sodium salt) | 14.0 |
| 1,2 propylene glycol | 7.8 |
| Soap | 6.4 |
| Ethanol | 0.4 |
| Water | to 100 |

Compounds were added to a laundry liquor comprising either a liquid model composition MC2 or MC3, respectively, without polymer (additive dosage of 3% on weight of liquid model detergent (owod)) together with commercially obtained stained fabrics (from Center of Test Materials CFT Vlaardingen. P-H108: Clay, Ground soil, P-H115: Standard Clay; P-H144: Red Pottery Clay; P-H145: tennis Court Clay) and 5 g of commercially available soil ballast sheet wfk SBL 2004 (from wfk Testgewebe GmbH Brueggen). Washing conditions were 3 g/L detergent, liquor 250 mL, 30 min, 40° C., 4-fold determination. After wash the fabrics were rinsed and dried. The fabrics were instrumentally assessed before and after wash using the MACH5 multi area color measurement instrument from ColourConsult which gives Lab readings. From these Lab readings, AE values were calculated between unwashed and washed stain. The higher the AE value, the better is the performance. To better judge on the pure cleaning effect of the respective polymer sample itself, the obtained values were further expressed in AAE values vs reference without polymer (baseline correction for plain wash effect of detergent only). Again, the higher the values of AAE are observed the better is the performance, respectively.

As shown below in tables 4 and 7, respectively, the inventive examples show a comparable washing performance compared to the prior art example 1a (set as benchmark=100%). In some cases, the washing performance of the inventive example is even better than that of the benchmark. However, the biodegradability of each inventive example is by far better than that of the benchmark (as shown in table 4).

TABLE 6
Results of small-scale primary detergency (Lini-test) in model formulation
MC2 on commercially available stains as indicated below:

| | | | | | | | DDE | | DDE | DDE |
|---|---|---|---|---|---|---|---|---|---|---|
| | | | | | Primary | | stain #1 | DDE | stain #3 | stain #4 |
| inventive | | | | | detergency | DDE | Clay | stain #2 | Red | Tennis |
| example #/ | | | | | in % vs | sum | Ground | Stanley | Pottery | Court |
| comparative | amine/ | | | | performance | over all | Soil | Clay | Clay | Clay |
| example | imine | step a) | step b) | step c) | of 1a | stains | PCH108 | PCH115 | PCH144 | PH145 |
| #2 | N4 amine | 0.9 EO/NH | 1 CL/OH | 20 EO | 58 | 7.9 | 1.0 | 1.7 | 2.5 | 2.7 |
| #2* | N4 amine | 0.9 PO/NH | 0.9 CL/OH | 20 EO | 88 | 11.8 | 2.7 | 2.6 | 4.2 | 2.3 |
| #3 | PEI800 | 0.9 PO/NH | 0.9 CL/OH | 20 EO | 87 | 11.8 | 1.1 | 3.5 | 4.6 | 2.5 |
| #4 | PEI800 | 0.9 PO/NH | 1.8 CL/OH | 20 EO | 104 | 14.0 | 3.7 | 3.6 | 4.3 | 2.4 |
| #5 | PEI800 | 0.5 EO/NH | 0.5 CL/OH | 19.5 EO | 68 | 9.2 | 0.6 | 2.9 | 3.1 | 2.7 |
| #8 | PEI2000 | 0.9 PO/NH | 1 CL/OH | 20 EO | 85 | 11.4 | 2.2 | 2.7 | 3.2 | 3.4 |
| #9 | HMDA | 0.9 PO/NH | 1 CL/OH | 20 EO | 62 | 8.3 | 0.1 | 2.3 | 3.8 | 2.1 |
| #10 | PPI | 0.9 PO/NH | 1 CL/OH | 20 EO | 38 | 5.1 | 0.3 | 0.9 | 1.9 | 2.0 |
| #11 | PEI800 | 1.1BO/NH | 2.3 CL/OH | 23 EO | 91 | 12.3 | 2.1 | 3.0 | 3.9 | 3.3 |
| comparative | PEI800 | | | 20 EO | 100 | 13.5 | 1.9 | 4.0 | 5.2 | 2.4 |
| example 1 | | | | | | | | | | |

TABLE 7
Results of small-scale primary detergency (Linitest) in model formulation
MC3 on commercially available stains as indicated below

| | | | | | | | DDE | | DDE | DDE |
|---|---|---|---|---|---|---|---|---|---|---|
| | | | | | Primary | | stain #1 | DDE | stain #3 | stain #4 |
| inventive | | | | | detergency | DDE | Clay | stain #2 | Red | Tennis |
| example #/ | | | | | in % vs | sum | Ground | Stanley | Pottery | Court |
| comparative | amine/ | | | | performance | over all | Soil | Clay | Clay | Clay |
| example | imine | step a) | step b) | step c) | of 1a | stains | PCH108 | PCH115 | PCH144 | PH145 |
| #2 | N4 amine | 0.9 EO/NH | 1 CL/OH | 20 EO | 52 | 6.2 | 1.4 | 1.1 | 2.8 | 0.9 |
| #2* | N4 amine | 0.9 PO/NH | 0.9 CL/OH | 20 EO | 69 | 8.4 | 1.4 | 2.2 | 2.6 | 2.2 |
| #3 | PEI800 | 0.9 PO/NH | 0.9 CL/OH | 20 EO | 99 | 12.0 | 3.0 | 3.4 | 4.3 | 1.3 |
| #4 | PEI800 | 0.9 PO/NH | 1.8 CL/OH | 20 EO | 103 | 12.4 | 3.1 | 3.0 | 4.1 | 2.2 |
| #5 | PEI800 | 0.5 EO/NH | 0.5 CL/OH | 19.5 EO | 103 | 12.5 | 1.9 | 3.1 | 4.7 | 2.9 |
| #8 | PEI2000 | 0.9 PO/NH | 1 CL/OH | 20 EO | 101 | 12.2 | 3.9 | 3.6 | 2.8 | 1.9 |
| #9 | HMDA | 0.9 PO/NH | 1 CL/OH | 20 EO | 87 | 10.5 | 2.9 | 3.3 | 2.9 | 1.4 |
| #10 | PPI | 0.9 PO/NH | 1 CL/OH | 20 EO | 60 | 7.3 | 2.7 | 1.7 | 1.9 | 0.9 |
| comparative | PEI800 | | | 20 EO | 100 | 12.1 | 2.3 | 3.2 | 4.5 | 2.1 |
| example 1 | | | | | | | | | | |

3) Antigreying

The antigreying performance for selected polymers was determined in the launder-O-meter (LP2 Typ, SDL Atlas Inc., USA) in beakers of 1 L size under the following washing conditions.

TABLE 8

| | |
|---|---|
| Washing liquor | 250 ml |
| Washing time/temperature | 30 min at 30° C. |
| Dosage [detergent] | 4 g/L [Regular liquid detergent |
| | model formulation described |
| | in Table 1] |
| Washing cycles | 3 |
| Water hardness | 2.5 mmol/L; Ca²⁺:Mg²⁺:HCO₃ = 4:1:8 |
| Test fabrics | ~15 g [type see below] |
| Soil | 2.5 g [see details below] |

All ingredients % by weight relate to 100% active matter.

wfk test fabrics and wfk clay were purchased via wfk Testgewebe GmbH: 41379 Brüggen, Germany. Tissues were either used as received or cut into pieces as needed. Test fabrics used (10 cm×10 cm squares):

Cotton: wfk10A [standard cotton], wfk80A [cotton knitwear], wfk12A [cotton Terry cloth], EMPA 221 [cotton Cretone bleached], T-shirt according to EN/EC 60456

Synthetics: wfk20A [PES/Co blend], wfk30A [polyester], EMPA406 [polyamide]

Soil: The wfk clay slurry was prepared by homogenizing 120 g of wfk clay and 450 g deionized water, followed by addition of 30 g of an oil mixture that consists of peanut oil (75 parts, e.g. Brandle) and mineral oil (25 parts, lubricating oil 0-10-002) and subsequent homogenization.

The first cycle was run using the launder-O-meter beakers containing the test wash solution plus test fabrics and soil at 30° C. for 30 min. After wash, the test fabrics were rinsed and subjected to the next wash cycle. The process was repeated using the washed test fabrics and performing 3 cycles in total. New soil was used for each cycle.

After the 3 cycles, the test fabrics were rinsed in water, followed by drying at ambient room temperature overnight. The greying of the test fabrics was measured by determining the spectral reflectance R at 460 nm after washing using optical geometry of D:0° on Elrepho spectrometer from Datacolor, USA. Reflectance values R decrease with the visible greying of the fabrics, the higher the R value, the better the anti-greying performance. Summation of all the 5 cotton fabrics and the 3 “synthetic” fabrics, respectively, was performed to generate an overall R performance value. To better judge on the effect of the respective polymer sample vs the non-degradable reference, and also to compare results between different experimental runs, the obtained overall R values were then further expressed in % performance vs reference comparative example 1a.

TABLE 9
Anti-greying

| | (Poly) amine | | | | | | antigrey, LOM |
|---|---|---|---|---|---|---|---|
| patent example # | core | step a) | step b) | | step c) | | in % perf vs 1a |
| #1 | PEI800 | 0.9 EO/NH | 1 | CL/OH | 20 | EO | 94 |
| #4 | PEI800 | 0.9 PO/NH | 1.8 | CL/OH | 20 | EO | 98 |
| #5 | PEI800 | 0.5 EO/NH | 0.5 | CL/OH | 19.5 | EO | 99 |
| #6 | PEI800 | 0.5 EO/NH | 1 | CL/OH | 19.5 | EO | 96 |

| | | | | |
|---|---|---|---|---|
| comparative | PEI800 | 20 | EO | 100 |
| example 1 | | | | |

The inventive examples show a comparable anti-greying behavior compared to the prior art, but the biodegradability of the inventive examples is by far better compared to that of the prior art (as shown in table 1).

1. An alkoxylated polyalkylene imine or alkoxylated polyamine obtainable by a process comprising:
a) reacting i) at least one polyalkylene imine or at least one polyamine with ii) at least one first alkylene oxide (AO1), wherein 0.25 to 7.0 mol of alkylene oxide (AO1) is employed per mol of NH-functionality of polyalkylene imine or of polyamine, in order to obtain a first intermediate (I1),
b) reacting the first intermediate (I1) with at least one lactone and/or at least one hydroxy carbon acid, wherein 0.25 to 10 mol of lactone and/or of hydroxy carbon acid is employed per mol of NH-functionality of polyalkylene imine or of polyamine as employed in step a), in order to obtain a second intermediate (I2), and
c) reacting the second intermediate (I2) with at least one second alkylene oxide (AO2), wherein at least 1 mol of alkylene oxide (AO2) is employed per mol of NH-functionality of polyalkylene imine or of polyamine as employed in step a), in order to obtain the alkoxylated polyalkylene imine or the alkoxylated polyamine.

2. The alkoxylated polyalkylene imine or alkoxylated polyamine according to claim 1, wherein the at least one polyalkylene imine or the at least one polyamine as employed in step a) is defined according to general formula (I) 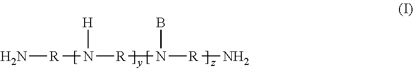
in which the variables are each defined as follows:
R represents identical or different,
i) linear or branched C₂-C₁₂-alkylene radicals or
ii) an etheralkyl unit of the following formula (III): 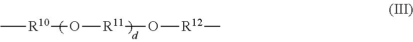
in which the variables are each defined as follows:
R¹⁰, R¹¹, R¹² represent identical or different, linear or branched C₂-C₆-alkylene radicals and
d is an integer having a value in the range of 0 to 50 or
iii) C₅-C₁₀ cycloalkylene radicals optionally substituted with at least one C₁-C₃ alkyl;
B represents a continuation of the polyalkylene imine by branching; and
y and z are each an integer having a value in the range of 0 to 150.

3. The alkoxylated polyalkylene imine or alkoxylated polyamine according to claim 1 containing at least one residue according to general formula (IIa) 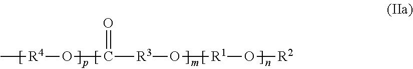
in which the variables are each defined as follows:
R¹ represents C₂-C₂₂-(1,2-alkylene) radicals;
R² represents hydrogen and/or C₁-C₂₂-alkyl and/or C₇-C₂₂-aralkyl;
R³ represents linear or branched C₁-C₂₂-alkylene radicals;
R⁴ represents C₂-C₂₂-(1,2-alkylene) radicals;
m is an integer having a value of at least 1 to 10;
n is an integer having a value of at least 5 to 100; and
p is an integer having a value of at least 1 to 5.

4. The alkoxylated polyalkylene imine or alkoxylated polyamine according to claim 1 containing at least one residue according to general formula (IIb) 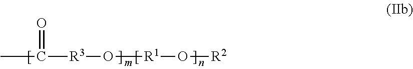
in which the variables are each defined as follows:
R¹ represents C₂-C₂₂-(1,2-alkylene) radicals;
R² represents hydrogen and/or C₁-C₂₂-alkyl and/or C₇-C₂₂-aralkyl;
R³ represents linear or branched C₁-C₂₂-alkylene radicals;
m is an integer having a value of at least 1 to 10; and
n is an integer having a value of at least 5 to 100.

5. The alkoxylated polyalkylene imine or alkoxylated polyamine according to claim 1 containing at least one residue according to general formula (IIc) 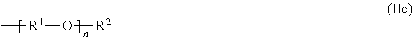
in which the variables are defined as follows:
R¹ represents C₂-C₂₂-(1,2-alkylene) radicals;
R² represents hydrogen and/or C₁-C₂₂-alkyl;
n is an integer having a value of at least 5 to 100.

6. The alkoxylated imine or alkoxylated polyamine according to claim 3, wherein the residue (IIa) accounts for at least 80 wt % of all residues (IIa), (IIb) and (IIIc) attached to the amino groups of the polyalkylene imine or polyamine as employed in step a).

7. The alkoxylated polyalkylene imine or alkoxylated polyamine according to claim 2, wherein
i) step a) is carried out in the presence of water and/or in the presence of a base catalyst, and/or
ii) the weight average molecular weight (Mw) of the polyalkylene imine or of the polyamine employed in step a) lies in the range of 50 to 10 000 g/mol.

8. The alkoxylated polyalkylene imine according to claim 2, wherein the variables are each defined as follows:
R is ethylene and/or propylene; and
the sum of y+z is an integer having a value in the range of 9 to 120.

9. The alkoxylated polyamine according to claim 2, wherein
y is an integer having a value in the range of 0 to 10;
z is 0; and
R represents identical or different, linear or branched C₂-C₁₂-alkylene radicals or an etheralkyl unit according to formula (III), wherein
d is from 1 to 5, and
R¹⁰, R¹¹, R¹² are independently selected from the group consisting of linear and branched C₃ to C₄ alkylene radicals.

10. The alkoxylated polyalkylene imine or alkoxylated polyamine according to claim 1, wherein up to 100% of the nitrogen atoms present in the alkoxylated polyalkylene imine or alkoxylated polyamine are quaternized.

11. The alkoxylated polyalkylene imine or alkoxylated polyamine according to claim 1, wherein
i) in step b) the lactone is caprolactone, and/or
ii) in step b) the hydroxy carbon acid is lactic acid or glycolic acid, and/or
iii) in step a) the first alkylene oxide (AO1) is at least one C₂-C₂₂-epoxide, and/or
iv) in step c) the second alkylene oxide (AO2) is at least one C₂-C₂₂-epoxide.

12. The alkoxylated polyalkylene imine or alkoxylated polyamine according to claim 1, wherein
i) in step a) 0.5 to 2 mol of alkylene oxide (AO1) is employed per mol of NH-functionality of polyalkylene imine or of polyamine, and/or
ii) in step b) 0.5 to 3 mol of lactone and/or of hydroxy carbon acid is employed per mol of NH-functionality of polyalkylene imine or of polyamine as employed in step a), and/or
iii) in step c) 5 to 30 mol of alkylene oxide (AO2) is employed per mol of NH-functionality of polyalkylene imine or of polyamine as employed in step a).

13. A method of using the alkoxylated polyalkylene imine or alkoxylated polyamine of claim 1, the method comprising using the alkoxylated polyalkylene imine or alkoxylated polyamine in cleaning compositions, in fabric and home care products, in cosmetic formulations, as crude oil emulsion breaker, in pigment dispersions for ink jet inks, in formulations for electro plating, in cementitious compositions and/or as dispersant for agrochemical formulations.

14. The method according to claim 13, wherein the method comprises using the alkoxylated polyalkylene imine or alkoxylated polyamine for
i) clay removal, and/or
ii) soil removal of particulate stains, and/or
iii) dispersion and/or emulsification of soils, and/or
iv) modification of treated surface to improve removal upon later re-soiling, and/or
v) whiteness improvement and/or
vi)—when at least one enzyme selected from the group consisting of lipases, hydrolases, amylases, proteases, cellulases, hemicellulases, phospholipases, esterases, pectinases, lactases and peroxidases, and combinations of at least two of the foregoing types, is present—additionally for improvement of oily/fatty stains, food stain removal and/or removal of complex stains.

15. A cleaning composition, fabric and home care product, cosmetic formulation, crude oil emulsion breaker, pigment dispersion for ink jet inks, formulation for electro plating, cementitious composition and/or dispersant for agrochemical formulations, comprising at least one alkoxylated polyalkylene imine or alkoxylated polyamine according to claim 1.

16. The cleaning composition according to claim 15, wherein the cleaning composition is suitable for
i) clay removal, and/or
ii) soil removal of particulate stains, and/or
iii) dispersion and/or emulsification of soils, and/or
iv) modification of treated surface to improve removal upon later re-soiling, and/or
v) whiteness improvement and/or
vi)—when at least one enzyme selected from the group consisting of lipases, hydrolases, amylases, proteases, cellulases, hemicellulases, phospholipases, esterases, pectinases, lactases and peroxidases, and combinations of at least two of the foregoing types, is present—additionally for improvement of oily/fatty stains, food stain removal and/or removal of complex stains, and/or
vii) additionally comprising at least one enzyme selected from the group consisting of lipases, hydrolases, amylases, proteases, cellulases, hemicellulases, phospholipases, esterases, pectinases, lactases and peroxidases, and combinations of at least two of the foregoing types, and/or
viii) for oily/fatty stain removal, food stain removal and/or removal of complex stains, when at least one enzyme according to vii) is present.

17. The alkoxylated imine or alkoxylated polyamine according to claim 3, wherein the residue (IIa) accounts for at least 90 wt.-% of all residues (IIa), (IIb) and (IIc) attached to the amino groups of the polyalkylene imine or polyamine as employed in step a).

18. The alkoxylated imine or alkoxylated polyamine according to claim 3, wherein the residue (IIa) accounts for at least 95 wt.-% of all residues (IIa), (IIb) and (IIc) attached to the amino groups of the polyalkylene imine or polyamine as employed in step a).

19. The alkoxylated polyalkylene imine or alkoxylated polyamine according to claim 1, wherein
i) step a) is carried out in the presence of water and/or in the presence of a base catalyst, and/or
ii) the weight-average molecular weight (Mw) of the polyalkylene imine or of the polyamine employed in step a) lies in the range of 500 to 5000 g/mol.

20. The alkoxylated polyalkylene imine or alkoxylated polyamine according to claim 1, wherein
i) step a) is carried out in the presence of water and/or in the presence of a base catalyst, and/or
ii) the weight-average molecular weight (Mw) of the polyalkylene imine or of the polyamine employed in step a) lies in the range of 600 to 2 500 g/mol.
